(19) United States
(12) Patent Application Publication
(10) Pub. No.: US 2004/0246229 A1
(43) Pub. Date: Dec. 9, 2004

(54) Information display system, information processing apparatus, pointing apparatus, and pointer cursor display method in information display system

(75) Inventor: Norihiko Yamada, Okaya-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/807,453

(22) Filed: Mar. 24, 2004

(30) Foreign Application Priority Data
Mar. 28, 2003 (JP) 2003-091330
Jan. 21, 2004 (JP) 2004-013212

(51) Int. Cl. G09G 5/00

(52) U.S. Cl. 345/156

(57) ABSTRACT

Using an imaged image taken by a pointing apparatus, information to determine a position to be pointed at is acquired so as to display a pointer marka camera built-in type portable telephone, for example, is employed as a pointing apparatus, and the range of an arbitrary position on a display image projected by image display device, such as a projector, is imaged by the imaging device, so as to output imaged image information. An information processing apparatus to which an information display apparatus is connected, includes pointing coordinate specification device to decide which range of the current display image the imaged image information from the pointing apparatus corresponds to, and to specify pointing coordinates by the pointing apparatus, from the result of the decision, display image information storage device to store therein display image information corresponding to the display image, and display image information generation device to composite and display a pointer cursor to and at the specified pointing coordinates on the display image information.

### BACKGROUND OF THE INVENTION

1. Field of Invention

The present invention relates to an information display system capable of acquiring the coordinate information of a pointing position, an information processing apparatus for use in the information display system, a pointing apparatus similarly for use in the information display system, and a pointer cursor display method in the information display system.

2. Description of Related Art

As one of image display projectors have recently come into wide use. When an information processing equipment (for example, personal computer) to which the projector is connected acquires the coordinates of an arbitrary position on a projection screen projected by the projector, a fixed camera or an optical sensor to image the projection screen is required in addition to a pointing device (a pointing stick, a laser pointer, or the like). Thus, an information display system becomes large in scale and is therefore problematic in point of versatility.

In order to address the problem, various proposals have heretofore been made. See “OPTICAL POINTING SYSTEM” in JP-A-6-308879, “POSITION DETECTION APPARATUS AND METHOD THEREFOR, AND PLANE ATTITUDE DETECTION APPARATUS AND METHOD THEREFOR” in, JP-A-2001-148025, “POINTING APPARATUS AND METHOD THEREFOR” in, JP-A-2001-166881, “POSITION DETECTION APPARATUS AND METHOD THEREFOR” in JP-A-2001-325069, and “COMPUTER PRESENTATION SYSTEM AND METHOD WITH OPTICAL TRACKING OF WIRELESS POINTER” in U.S. Pat. No. 6,275,214.

JP-A-6-308879 discloses that a light emitting element is disposed on a display screen. Light emitted by the light emitting element is received by a photoelectric conversion element disposed on an indicator (which plays the role of a pointing apparatus). The direction of the axis of the indicator is calculated from the output signal of the photoelectric conversion element. A pointer cursor is displayed at a position corresponding to the axial direction. One or more light emitting element must be disposed on the display screen in order to detect the position.

In each of JP-A-2001-148025, JP-A-2001-166881, and JP-A-2001-325069, and an imaging device (a camera) is employed as a pointing apparatus. The camera takes the featuring image of a display image and acquires coordinates from the featuring shape thereof. Therefore, the featuring shape needs to be contained in the image which is taken by the camera. The rectangle of a projection screen or a geometrical pattern displayed on the display image, for example, needs to be taken by the camera.

In JP-A-2001-325069, several objects serving as markers must be arranged at individual positions on a display screen, so that even the objects irrelevant to the essential contents of the image are displayed.

In U.S. Pat. No. 6,275,214, a pointing position is detected in such a way that a certain position of a display image displayed on a screen is pointed at by a beam which is emitted from a hand-held optical beam pointer (such as laser pointer). The image of the position is imaged by an imaging device and that the image that is imaged is processed by a computer.

In U.S. Pat. No. 6,275,214, the laser pointer or the like is employed as a pointing device. Since a laser pointer is not possessed quite commonly by a user, the sponsor side needs to prepare the laser pointer being the pointing device in, for example, a presentation hall. Moreover, regarding the beam which is emitted from the laser pointer, a problem is pointed out in the aspect of safety.

In the technique of U.S. Pat. No. 6,275,214 the position pointed at by the laser pointer or the like is merely detected as the pointing position. Hence, such an operation as inputting any command at the pointing position cannot be performed. Since the laser pointer does not have the function of inputting a command or the like, it is difficult to realize the operation of performing another operation (for example, the command input) at the pointing position.

In JP-A-2001-148025, JP-A-2001-166881, JP-A-2001-325069 and U.S. Pat. No. 6,275,214, the pointing position is acquired as absolute coordinates and the acquisition as relative coordinates is not considered.

### SUMMARY OF THE INVENTION

Therefore, the present invention makes possible the specification of a pointing position by employing a portable equipment which a user possesses commonly, as a pointing apparatus without installing a fixed camera or an optical sensor and provides an information display system which makes possible the command input, such as data display at the pointing position, an information processing apparatus, a pointing apparatus, and a pointer cursor display method in the information display system.

(1) The information display system of an aspect of the present invention acquires a pointing position as absolute coordinates and, is an information display system having an information processing apparatus, an information display apparatus that displays information held in the information processing apparatus, on a display surface, and a pointing apparatus which points at an arbitrary position on a display image displayed by the information display apparatus. The pointing apparatus includes an imaging device that images a range containing the position at which the pointing apparatus is to point on the display image, and outputs imaged image information corresponding to the range. The information processing apparatus includes: a pointing coordinate specification device to accept the imaged image information from the pointing apparatus, to decide which part of display image information corresponding to the display image at an imaging point of time the imaged image information corresponds to, and to specify coordinates of the position at which the pointing apparatus is to point, as pointing coordinates from a result of the decision; a display image information storage device to store the display image information therein: and a display image information generation device to composite and display a pointer cursor to and at the specified pointing coordinates on the display image information.

(2) The information display system of an aspect of the present invention acquires a pointing position as absolute coordinates and may be constructed as an information display system having an information processing apparatus, an information display apparatus that displays information held in the information processing apparatus, on a display surface, and a pointing apparatus which points at an arbitrary position on a display image displayed by the information display apparatus. The pointing apparatus includes: an imaging device that images a range containing the position at which the pointing apparatus is to point on the display image and outputs imaged image information corresponding to the range, and a pointing coordinate specification device to accept the imaged image information from the imaging device, decide which part of display image information corresponding to the display image at an imaging point of time the imaged image information corresponds to, and specify coordinates of the position at which the pointing apparatus is to point, as pointing coordinates from a result of the decision. The information processing apparatus includes: a display image information storage device to store the display image information therein and a display image information generation device to composite and display a pointer cursor to and at the specified pointing coordinates on the display image information.

(3) The information display system of an aspect of the present invention acquires a pointing position as absolute coordinates and may be constructed as an information display system having an information processing apparatus, an information display apparatus that displays information held in the information processing apparatus, on a display surface, and a pointing apparatus which points at an arbitrary position on a display image displayed by the information display apparatus. The pointing apparatus includes: an imaging device that images a range containing the position at which the pointing apparatus is to point on the display image; and outputs imaged image information corresponding to the range. The information processing apparatus includes: a pointing coordinate specification device to accept the imaged image information from the pointing apparatus, to decide which part of display image information corresponding to the display image at an imaging point of time the imaged image information corresponds to, and to specify coordinates of the position at which the pointing apparatus is to point, as pointing coordinates from a result of the decision; a display image information storage device to store therein the display image information corresponding to the display image; and a display image information generation device to generate the image information stored in the display image information storage device, as the display image information, and composite and display a pointer cursor to and at the pointing coordinates on the display image information as specified by the pointing coordinate specification device.

(4) The information display system of an aspect of the present invention acquires a pointing position as absolute coordinates and may be constructed as an information display system having an information processing apparatus, an information display apparatus that displays information held in the information processing apparatus, on a display surface, and a pointing apparatus which points at an arbitrary position on a display image displayed by the information display apparatus. The pointing apparatus includes: an imaging device that images a range containing the position at which the pointing apparatus is to point on the display image, and outputs imaged image information corresponding to the range; and a pointing coordinate specification device to accept the imaged image information from the imaging device, to decide which part of display image information corresponding to the display image at an imaging point of time the imaged image information corresponds to, and to specify coordinates of the position at which the pointing apparatus is to point, as pointing coordinates from a result of the decision. The information processing apparatus includes: a display image information storage device to store therein the display image information corresponding to the display image; and a display image information generation device to generate the image information stored in the display image information storage device, as the display image information, and composite and display a pointer cursor to and at the pointing coordinates on the display image information as specified by the pointing coordinate specification device.

(5) In the information display system, as defined in any of the above described (1) through (4), the range to be imaged may be a imagable range which is set by a collimation device included in the imaging device. The central part of the imagable range set by the collimation device is the position at which the pointing apparatus is to point, the coordinates of the position being acquired as the pointing coordinates.

(6) In the information display system, as defined in any of the above described (1) through (5), the decision, on which part of the display image information corresponding to the display image at the imaging point of time the imaged image information corresponds to, may be rendered by generating template image information from the imaged image information, and then performing pattern matching between the template image information and the display image information corresponding to the display image at the imaging point of time.

(7) In the information display system, as defined in any of the above described (1) through (6), the pointing apparatus may be a portable information equipment which has an imaging function and a communication function.

(8) In the information display system, as defined in any of the above described (1) through (7), the pointing apparatus may include a command input device. The information processing apparatus may include a command processing device to accept and process a command from the pointing apparatus. In the information processing apparatus, when the command is given from the command input device after the specification of the pointing coordinates, the command process is performed so as to reflect a result of the process on the pointing coordinates.

(9) The information processing apparatus of an aspect of the present invention, for use in an information display system which acquires a pointing position as absolute coordinates, is an information processing apparatus for use in the information display system as defined in the above described (1) or (3). Included are functions of accepting the imaged image information outputted from the pointing apparatus, deciding which part of the display image information, corresponding to the display image at the imaging point of time, the imaged image information corresponds to, specifying the position at which the pointing apparatus is to point, as the pointing coordinates from the result of the decision, and thereafter compositing and displaying the pointer cursor to and at the specified pointing coordinates on the display image information.

(10) The pointing apparatus of an aspect of the present invention, for use in an information display system which acquires a pointing position as absolute coordinates, is a pointing apparatus for use in the information display system as defined in the above described (2) or (4), includes functions of deciding which part of the display image information corresponding to the display image at the imaging point of time the imaged image information by the imaging device corresponds to, and specifying the coordinates of the position at which the pointing apparatus is to point, as the pointing coordinates from the result of the decision.

(11) The data processing program of the information processing apparatus of an aspect of the present invention, for use in an information display system which acquires a pointing position as absolute coordinates, is a data processing program of an information processing apparatus in which data processing steps to be performed by the information processing apparatus as defined in the above described (9) are described, includes accepting the imaged image information outputted from the pointing apparatus, and deciding which part of the display image information corresponding to the display image at the imaging point of time the imaged image information corresponds to, and specifying the position at which the pointing apparatus is to point, as the pointing coordinates from the result of the decision, and thereafter compositing and displaying the pointer cursor to and at the specified pointing coordinates on the display image information.

(12) The data processing program of the pointing apparatus of an aspect of the present invention, for use in an information display system which acquires a pointing position as absolute coordinates, is that data processing program of a pointing apparatus in which data processing steps to be performed by the pointing apparatus as defined in the above described (10) are described, includes deciding which part of the display image information corresponding to the display image at the imaging point of time the imaged image information from the imaging device corresponds to, and specifying the coordinates of the position at which the pointing apparatus is to point, as the pointing coordinates from the result of the decision.

(13) The pointer cursor display method of an aspect of the present invention, in an information display system which acquires a pointing position as absolute coordinates, is a pointer cursor display method in an information display system having an information processing apparatus, an information display apparatus which displays information held in the information processing apparatus, on a display surface, and a pointing apparatus which points at an arbitrary position on a display image displayed by the information display apparatus; the pointing apparatus images a range containing the position at which it is to point on the display image, by an imaging device included in the pointing apparatus. The imaging device outputs imaged image information corresponding to the range, onto the information processing apparatus side. The information processing apparatus side accepts the imaged image information from the pointing apparatus, decides which part of display image information corresponding to the display image at an imaging point of time the imaged image information corresponds to, specifies the position at which the pointing apparatus is to point, as pointing coordinates from a result of the decision, and thereafter composites and displays a pointer mark, to and at, the specified pointing coordinates on the display image information.

(14) The pointer cursor display method of an aspect of the present invention, in an information display system which acquires a pointing position as absolute coordinates, may be a pointer cursor display method in an information display system having an information processing apparatus, an information display apparatus which displays information held in the information processing apparatus, on a display surface, and a pointing apparatus which points at an arbitrary position on a display image displayed by the information display apparatus. The pointing apparatus performs processing of imaging a range containing the position at which it is to point on the display image, by an imaging device included in the pointing apparatus, and thereafter obtaining imaged image information corresponding to the range, deciding which part of display image information corresponding to the display image at an imaging point of time the imaged image information corresponds to, specifying the position at which the pointing apparatus is to point, as pointing coordinates from a result of the decision, and outputting pointing coordinate information for the specified pointing coordinates, onto the information processing apparatus side. The information processing apparatus side performs processing of compositing and displaying a pointer mark, to and at, the pointing coordinate corresponding to the pointing coordinate information delivered from the pointing apparatus.

(15) In the pointer cursor display method in the information display system as defined in the above described (13) or (14), the range to be imaged may be an imagable range which is set by a collimation device included in the imaging device. The central part of the imagable range, set by the collimation device is the position at which the pointing apparatus is to point, coordinates of the position being acquired as the pointing coordinates.

(16) In the pointer cursor display method in the information display system as defined in any of the above described (13) through (15), the decision on which part of the display image information, corresponding to the display image at the imaging point of time the imaged image information corresponds to, may be rendered by generating template image information from the imaged image information, and then performing pattern matching between the template image information and the display image information corresponding to the display image at the imaging point of time.

(17) The information display system of an aspect of the present invention acquires a pointing position as relative coordinates and is an information display system having an information processing apparatus, an information display apparatus which displays information held in the information processing apparatus, on a display surface, and a pointing apparatus which points at an arbitrary position on a display image displayed by the information display apparatus. The pointing apparatus includes: an imaging device that images an arbitrary range which is to be imaged by the pointing apparatus, and outputs imaged image information corresponding to the range; and a pointing coordinate motion vector calculation device to compare the imaged image information at a current point of time and imaged image information temporally preceding the current point of time, as obtained by imaging a plurality of times by or without changing at least one of an imaging position and an imaging angle based on the imaging device. Then a pointing coordinate motion vector is calculated from a result of the comparison. The information processing apparatus includes a display image information storage device to store therein display image information corresponding to the display image, and a display image information generation device to composite a pointer cursor displayed on the display image information at the current point of time, to the display image information, and then displaying the pointer cursor at the position which is distant in correspondence with the pointing coordinate motion vector calculated by the pointing apparatus.

(18) The information display system of an aspect of the present invention acquires a pointing position as relative coordinates and may be constructed as an information display system having an information processing apparatus, an information display apparatus which displays information held in the information processing apparatus, on a display surface, and a pointing apparatus which points at an arbitrary position on a display image displayed by the information display apparatus. The pointing apparatus includes an imaging device that images a certain arbitrary range, and outputs imaged image information corresponding to the range. The information processing apparatus includes a pointing coordinate motion vector calculation device to compare the imaged image information at a current point of time as obtained from the imaging device of the pointing apparatus and imaged image information temporally preceding the current point of time as obtained by imaging a plurality of times by or without changing at least one of an imaging position and an imaging angle of the imaging device of the pointing apparatus. Then a pointing coordinate motion vector is calculated from a result of the comparison. The information processing apparatus also includes a display image information storage device to store therein display image information corresponding to the display image, and a display image information generation device to composite a pointer cursor displayed on the display image information at the current point of time, to the display image information, and then displaying the pointer cursor at the position which is distant in correspondence with the pointing coordinate motion vector calculated by the pointing coordinate motion vector calculation device.

(19) The information display system of an aspect of the present invention acquires a pointing position as relative coordinates and may be constructed as an information display system having an information processing apparatus, an information display apparatus which displays information held in the information processing apparatus, on a display surface, and a pointing apparatus which points at an arbitrary position on a display image displayed by the information display apparatus. The pointing apparatus includes an imaging device that images an arbitrary range which is to be imaged by the pointing apparatus, and outputs imaged image information corresponding to the range, imaged image information storage device to store therein imaged image information temporally preceding a current point of time as obtained by imaging a plurality of times by or without changing at least one of an imaging position and an imaging angle based on the imaging device, and a pointing coordinate motion vector calculation device to compare the imaged image information at the current point of time and the imaged image information stored in the imaged image information storage device, and then calculate a pointing coordinate motion vector from a result of the comparison. The information processing apparatus includes a display image information storage device to store therein display image information corresponding to the display image, and a display image information generation device to generate the image information stored in the display image information storage device, as the display image information, and composite a pointer cursor displayed on the display image information at the current point of time, to the display image information, and then display the pointer cursor at the position which is distant in correspondence with the pointing coordinate motion vector calculated by the pointing apparatus.

(20) The information display system of an aspect of the present invention acquires a pointing position as relative coordinates and may be constructed as an information display system having an information processing apparatus, an information display apparatus that displays information held in the information processing apparatus, on a display surface, and a pointing apparatus which points at an arbitrary position on a display image displayed by the information display apparatus. The pointing apparatus includes an imaging device that images a certain arbitrary range, and outputs imaged image information corresponding to the range. The information processing apparatus includes an imaged image information storage device to store therein imaged image information temporally preceding a current point of time as obtained by imaging a plurality of times by or without changing at least one of an imaging position and an imaging angle of the imaging device of the pointing apparatus, a pointing coordinate motion vector calculation device to compare the imaged image information at the current point of time, as obtained from the imaging device of the pointing apparatus and the imaged image information stored in the imaged image information storage device, and then calculating a pointing coordinate motion vector from a result of the comparison, a display image information storage device to store therein display image information corresponding to the display image, and a display image information generation device to generate the image information stored in the display image information storage device, as the display image information, and composite a pointer cursor displayed on the display image information at the current point of time, to the display image information, and then displaying the pointer cursor at the position which is distant in correspondence with the pointing coordinate motion vector calculated by the pointing coordinate motion vector calculation device.

(21) In the information display system, as defined in any of the above described (17) through (20), the process to compare the imaged image information at the current point of time and the imaged image information temporally preceding the current point of time and then calculating the pointing coordinate motion vector from the result of the comparison, may perform pattern matching between template image information generated from the imaged image information at the current point of time, and the imaged image information temporally preceding the current point of time, thereby to decide which part of the imaged image information temporally preceding the current point of time, the imaged image information at the current point of time corresponds to. Whereupon it finds a movement magnitude and a moving direction of the imaged image information at the current point of time, on the basis of a result of the decision, so as to calculate the pointing coordinate motion vector from the found movement magnitude and moving direction.

(22) In the information display system as defined in any of the above described (17) through (21), the pointing apparatus may be a portable information equipment which has an imaging function and a communication function.

(23) In the information display system as defined in any of the above described (17) through (22), the pointing apparatus may include a command input device. The information processing apparatus may include a command processing device to accept and process a command from the pointing apparatus. In the information processing apparatus, when the command is given from the command input device after specification of pointing coordinates, the command process may be performed so as to reflect a result of the process on the pointing coordinates.

(24) The pointing apparatus of an aspect of the present invention for use in an information display system which acquires a pointing position as relative coordinates is a pointing apparatus for use in an information display system as defined in the above described (17) or (19), and includes functions of comparing the imaged image information at the current point of time and the imaged image information temporally preceding the current point of time, as are obtained in such a way that the arbitrary range is imaged a plurality of times, by or without, changing at least one of the imaging position and the imaging angle, by the imaging device included in the pointing apparatus, and then calculating the pointing coordinate motion vector from the result of the comparison, so as to output the pointing coordinate motion vector to the information processing apparatus.

(25) The information processing apparatus of an aspect of the present invention for use in an information display system which acquires a pointing position as relative coordinates, is an information processing apparatus for use in an information display system as defined in the above described (18) or (20), including functions of comparing the imaged image information at the current point of time and the imaged image information temporally preceding the current point of time, as are obtained in such a way that the imaging is performed the plurality of times, by or without, changing at least one of the imaging position and the imaging angle of the imaging device included in the pointing apparatus, calculating the pointing coordinate motion vector from the result of the comparison, and compositing the pointer cursor displayed on the display image at the current point of time, to the display image information, and then displaying the pointer cursor at the position which is distant in correspondence with the calculated pointing coordinate motion vector.

(26) The data processing program of the pointing apparatus of an aspect of the present invention for use in an information display system which acquires a pointing position as relative coordinates, is that data processing program of a pointing apparatus in which data processing steps to be performed by the pointing apparatus, as defined in the above described (24), include the step of comparing the imaged image information at the current point of time and the photographed image information temporally preceding the current point of time as are obtained in such a way that the arbitrary range is photographed the plurality of times, by or without, changing at least one of the imaging position and the imaging angle, by the imaging device included in the pointing apparatus, and then calculating the pointing coordinate motion vector from the result of the comparison, and the output step of outputting the pointing coordinate motion vector to the information processing apparatus.

(27) The data processing program of the information processing apparatus of an aspect of the present invention for use in an information display system which acquires a pointing position as relative coordinates, is that data processing program of an information processing apparatus in which data processing steps to be performed by the information processing apparatus as defined in the above described (25) are described, include the step of comparing the photographed image information at the current point of time and the imaged image information temporally preceding the current point of time, as are obtained in such a way that the imaging is performed the plurality of times, by or without, changing at least one of the imaging position and the imaging angle of the imaging device included in the pointing apparatus, and then calculating the pointing coordinate motion vector from the result of the comparison, and the step of compositing the pointer cursor displayed on the display image at the current point of time, to the display image information, and then displaying the pointer cursor at the position which is distant in correspondence with the calculated pointing coordinate motion vector.

(28) A pointer cursor display method in the information display system of an aspect of the present invention in the case of acquiring a pointing position as relative coordinates, is a pointer cursor display method in an information display system having an information processing apparatus, an information display apparatus which is capable of displaying information held in the information processing apparatus, on a display surface, and a pointing apparatus which points at an arbitrary position on a display image displayed by the information display apparatus; the pointing apparatus comparing imaged image information at a current point of time and imaged image information temporally preceding the current point of time, as are obtained in such a way that an arbitrary range is imaged a plurality of times, by or without, changing at least one of an imaging position and an imaging angle of an imaging device included in the pointing apparatus, by the imaging device, whereupon it calculates a pointing coordinate motion vector from a result of the comparison, so as to output the pointing coordinate motion vector to the information processing apparatus; and that the information processing apparatus side composites a pointer cursor displayed on the display image at the current point of time, to the display image information, and displays the pointer cursor at the position which is distant in correspondence with the pointing coordinate motion vector calculated by the pointing apparatus.

(29) A pointer cursor display method in the information display system of an aspect of the present invention, in the case of acquiring a pointing position as relative coordinates, may be a pointer cursor display method in an information display system having an information processing apparatus, an information display apparatus which is capable of displaying information held in the information processing apparatus, on a display surface, and a pointing apparatus which points at an arbitrary position on a display image displayed by the information display apparatus. The pointing apparatus performs processing of imaging an arbitrary range by an imaging device included in the pointing apparatus; and the information processing apparatus side performs processing of comparing imaged image information at a current point of time and imaged image information temporally preceding the current point of time, as are obtained in such a way that the imaging is performed a plurality of times, by or without, changing at least one of an imaging position and an imaging angle of the imaging device included in the pointing apparatus, calculating a pointing coordinate motion vector from a result of the comparison, and compositing a pointer cursor displayed on the display image at the current point of time, to the display image information, and then displaying the pointer cursor at the position which is distant in correspondence with the calculated pointing coordinate motion vector.

(30) In the pointer cursor display method in the information display system as defined in the above described (28) or (29), the process to compare the imaged image information at the current point of time and the imaged image information temporally preceding the current point of time and then calculating the pointing coordinate motion vector from the result of the comparison may perform pattern matching between template image information generated from the imaged image information at the current point of time and the imaged image information temporally preceding the current point of time, thereby to decide which part of the imaged image information temporally preceding the current point of time the imaged image information at the current point of time corresponds to, whereupon it finds a movement magnitude and a moving direction of the imaged image information at the current point of time, on the basis of a result of the decision, so as to calculate the pointing coordinate motion vector from the found movement magnitude and moving direction.

(31) The information display system of an aspect of the present invention, in which an information display system acquiring a pointing position as absolute coordinates and an information display system acquiring a pointing position as relative coordinates are combined, is an information display system having an information processing apparatus, an information display apparatus which is capable of displaying information held in the information processing apparatus, on a display surface, and a pointing apparatus which points at an arbitrary position on a display image displayed by the information display apparatus. The pointing apparatus includes: an imaging device that images an arbitrary range which is to be imaged by the pointing apparatus, and outputs imaged image information corresponding to the range; and a pointing coordinate motion vector calculation device to compare the imaged image information at a current point of time and imaged image information temporally preceding the current point of time, as obtained by imaging a plurality of times, by or without, changing at least one of an imaging position and an imaging angle based on the imaging device; and then calculating a pointing coordinate motion vector from a result of the comparison. The information processing apparatus includes a display image information storage device to store therein display image information corresponding to the display image, a pointing coordinate specification device to find a tentative pointing position of a pointer cursor after being moved, on the basis of the display image information, the imaged image information from the pointing apparatus, and the pointing coordinate motion vector, and specifying a pointing position of the pointer cursor after being moved, as pointing coordinates within a range containing the tentative pointing position, and a display image information generation device to composite and display the pointer mark, to and at, the specified pointing coordinates on the display image information.

(32) The information display system of an aspect of the present invention, in which an information display system acquiring a pointing position as absolute coordinates and an information display system acquiring a pointing position as relative coordinates are combined, may be constructed as an information display system having an information processing apparatus, an information display apparatus that displays information held in the information processing apparatus, on a display surface, and a pointing apparatus which points at an arbitrary position on a display image displayed by the information display apparatus. The pointing apparatus includes an imaging device images an arbitrary range which is to be imaged by the pointing apparatus, and outputs imaged image information corresponding to the range. The information processing apparatus includes a pointing coordinate motion vector calculation device to compare the imaged image information at a current point of time and imaged image information temporally preceding the current point of time as obtained by imaging a plurality of times by or without changing at least one of an imaging position and an imaging angle attained by the imaging device of the pointing apparatus, and then calculating a pointing coordinate motion vector from a result of the comparison, a display image information storage device to store therein display image information corresponding to the display image, a pointing coordinate specification device to find a tentative pointing position of a pointer cursor after being moved, on the basis of the display image information, the calculated pointing coordinate motion vector, and the imaged image information from the pointing apparatus, and specifying a pointing position of the pointer cursor after being moved, as pointing coordinates within a range containing the tentative pointing position, and a display image information generation device to composite and display the pointer cursor to and at the specified pointing coordinates on the display image information.

(33) The information display system of an aspect of the present invention, in which an information display system acquiring a pointing position as absolute coordinates and an information display system acquiring a pointing position as relative coordinates are combined, may be constructed as an information display system having an information processing apparatus, an information display apparatus which is capable of displaying information held in the information processing apparatus, on a display surface, and a pointing apparatus which points at an arbitrary position on a display image displayed by the information display apparatus. The pointing apparatus includes an imaging device that images an arbitrary range which is to be imaged by the pointing apparatus, and outputs imaged image information corresponding to the range, a pointing coordinate motion vector calculation device to compare the imaged image information at a current point of time and imaged image information temporally preceding the current point of time as obtained by imaging a plurality of times by or without changing at least one of an imaging position and an imaging angle based on the imaging device, and then calculating a pointing coordinate motion vector from a result of the comparison, and pointing coordinate specification device to find a tentative pointing position of a pointer cursor after being moved, on the basis of the imaged image information, the pointing coordinate motion vector, and the display image information, and then specifying a pointing position of the pointer cursor after being moved, as pointing coordinates within a range containing the tentative pointing position. The information processing apparatus includes a display image information storage device to store therein display image information corresponding to the display image, and a display image information generation device to composite and display the pointer cursor to and at the specified pointing coordinates on the display image information.

(34) In the information display system in any of the above described (31) through (33), the pointing coordinate specification process, which is performed by the pointing coordinate specification device, is permitted by setting the range with reference to the tentative pointing position, computing correlations at respective positions by performing pattern matching between the imaged image and the display image information at the imaging point of time within the set range, and specifying the pointing coordinates after the motion, on the basis of the computed correlations.

In the information display system in each of the above described (31), (32), (33) and (34), the contents defined in the above described (5), (6), (7), (8) and (21) can be applied.

(35) The information processing apparatus of an aspect of the present invention, for use in the information display system of an aspect of the present invention, in which an information display system acquiring a pointing position as absolute coordinates and an information display system acquiring a pointing position as relative coordinates are combined, is an information processing apparatus for use in an information display system as defined in the above described (31), including functions of finding the tentative pointing position of the pointer cursor after being moved, on the basis of the display image information stored in the display image information storage device, the imaged image information from the pointing apparatus, and the pointing coordinate motion vector, specifying the pointing position of the pointer cursor after being moved, as the pointing coordinates within the range containing the tentative pointing position, and compositing and displaying the pointer cursor to and at the specified pointing coordinates.

(36) The pointing apparatus of an aspect of the present invention, for use in the information display system of an aspect of the present invention, in which an information display system acquiring a pointing position as absolute coordinates and an information display system acquiring a pointing position as relative coordinates are combined, is a pointing apparatus for use in an information display system as defined in the above described (31), including functions of comparing the imaged image information at the current point of time and the imaged image information temporally preceding the current point of time, as are obtained in such a way that the arbitrary range is imaged the plurality of times, by or without, changing at least one of the imaging position and the imaging angle, by the imaging device included in the pointing apparatus, and then calculating the pointing coordinate motion vector from the result of the comparison, so as to output the pointing coordinate motion vector to the information processing apparatus.

(37) The information processing apparatus of an aspect of the present invention for use in the information display system of an aspect of the present invention, in which an information display system acquiring a pointing position as absolute coordinates and an information display system acquiring a pointing position as relative coordinates are combined, is an information processing apparatus for use in an information display system as defined in the above described (32), including functions of comparing the imaged image information at the current point of time and the imaged image information temporally preceding the current point of time, as are obtained in such a way that the arbitrary range is imaged the plurality of times, by or without, changing at least one of the imaging position and the imaging angle, by the imaging device included in the pointing apparatus, calculating the pointing coordinate motion vector from the result of the comparison, finding the tentative pointing position of the pointer cursor after being moved, on the basis of the calculated coordinate motion vector, the imaged image information, and the display image information, specifying the pointing position of the pointer cursor after being moved, as the pointing coordinates within the range containing the tentative pointing position, and compositing and displaying the pointer cursor to and at the specified pointing coordinates.

(38) The pointing apparatus of an aspect of the present invention for use in the information display system of an aspect of the present invention, in which an information display system acquiring a pointing position as absolute coordinates and an information display system acquiring a pointing position as relative coordinates are combined, is a pointing apparatus for use in an information display system as defined in the above described (33), including functions of comparing the imaged image information at the current point of time and the imaged image information temporally preceding the current point of time, as are obtained in such a way that the arbitrary range is imaged the plurality of times, by or without, changing at least one of the imaging position and the imaging angle, by the imaging device included in the pointing apparatus, calculating the pointing coordinate motion vector from the result of the comparison, finding the tentative pointing position of the pointer cursor after being moved, on the basis of the pointing coordinate motion vector, the imaged image information at the imaging point of time, and the display image information, and specifying the pointing position of the pointer cursor after being moved, as the pointing coordinates within the range containing the tentative pointing position.

(39) The data processing program of the information processing apparatus of an aspect of the present invention for use in the information display system of an aspect of the present invention, in which an information display system acquiring a pointing position as absolute coordinates and an information display system acquiring a pointing position as relative coordinates are combined, is a data processing program of an information processing apparatus, in which data processing steps to be performed by the information processing apparatus as defined in the above described (35) are described, including the step of finding the tentative pointing position of the pointer cursor after being moved, on the basis of the display image information stored in the display image information storage device, the imaged image information from the pointing apparatus, and the pointing coordinate motion vector, the step of specifying the pointing position of the pointer cursor after being moved, as the pointing coordinates within the range containing the tentative pointing position, and the step of compositing and displaying the pointer cursor to and at the specified pointing coordinates.

(40) The data processing program of the pointing apparatus of as aspect of the present invention for use in the information display system of an aspect of the present invention, in which an information display system acquiring a pointing position as absolute coordinates and an information display system acquiring a pointing position as relative coordinates are combined, is a data processing program of a pointing apparatus, in which data processing steps to be performed by the pointing apparatus as defined in the above described (36) are described, including the step of comparing the imaged image information at the current point of time and the imaged image information temporally preceding the current point of time, as are obtained in such a way that the arbitrary range is imaged the plurality of times, by or without, changing at least one of the imaging position and the imaging angle, by the imaging device included in the pointing apparatus, and then calculating the pointing coordinate motion vector from the result of the comparison, and the step of outputting the pointing coordinate motion vector to the information processing apparatus.

(41) The data processing program of the information processing apparatus of an aspect of the present invention for use in the information display system of an aspect of the present invention, in which an information display system acquiring a pointing position as absolute coordinates and an information display system acquiring a pointing position as relative coordinates are combined, is a data processing program of an information processing apparatus, in which data processing steps to be performed by the information processing apparatus as defined in the above described (37) are described, including the step of comparing the imaged image information at the current point of time and the imaged image information temporally preceding the current point of time, as are obtained in such a way that the arbitrary range is imaged the plurality of times, by or without, changing at least one of the imaging position and the imaging angle of the imaging device included in the pointing apparatus, by the imaging device, and then calculating the pointing coordinate motion vector from the result of the comparison, the step of finding the tentative pointing position of the pointer cursor after being moved, on the basis of the calculated coordinate motion vector, the imaged image information, and the display image information, the step of specifying the pointing position of the pointer cursor after being moved, as the pointing coordinates within the range containing the tentative pointing position, and the step of compositing and displaying the pointer cursor to and at the specified pointing coordinates.

(42) The data processing program of the pointing apparatus of an aspect of the present invention for use in the information display system of an aspect of the present invention, in which an information display system acquiring a pointing position as absolute coordinates and an information display system acquiring a pointing position as relative coordinates are combined, is a data processing program of a pointing apparatus, in which data processing steps to be performed by the pointing apparatus as defined in the above described (38) are described, including the step of comparing the imaged image information at the current point of time and the imaged image information temporally preceding the current point of time, as are obtained in such a way that the arbitrary range is imaged the plurality of times, by or without, changing at least one of the imaging position and the imaging angle of the imaging device included in the pointing apparatus, by the imaging device, and then calculating the pointing coordinate motion vector from the result of the comparison, the step of finding the tentative pointing position of the pointer cursor after being moved, on the basis of the pointing coordinate motion vector, the imaged image information at the imaging point of time, and the display image information, and the step of specifying the pointing position of the pointer cursor after being moved, as the pointing coordinates within the range containing the tentative pointing position.

(43) A pointer cursor display method in the information display system of an aspect of the present invention, in which an information display system acquiring a pointing position as absolute coordinates and an information display system acquiring a pointing position as relative coordinates are combined, is a pointer cursor display method in an information display system having an information processing apparatus, an information display apparatus which displays information held in the information processing apparatus, on a display surface, and a pointing apparatus which points at an arbitrary position on a display image displayed by the information display apparatus; including the pointing apparatus comparing imaged image information at a current point of time and imaged image information temporally preceding the current point of time, as are obtained in such a way that an arbitrary range is imaged a plurality of times by or without changing at least one of an imaging position and an imaging angle of the imaging device included in the pointing apparatus, by the imaging device, whereupon it calculates a pointing coordinate motion vector from a result of the comparison, so as to output the pointing coordinate motion vector to the information processing apparatus. The information processing apparatus finds a tentative pointing position of a pointer cursor after being moved, on the basis of the imaged image information from the pointing apparatus, the pointing coordinate motion vector, and the display image information, that it specifies a pointing position of the pointer cursor after being moved, as pointing coordinates within a range containing the tentative pointing position, and that it composites and displays the pointer cursor to and at the specified pointing coordinates on the display image information corresponding to the display image.

(44) A pointer cursor display method in the information display system of an aspect of the present invention, in which an information display system acquiring a pointing position as absolute coordinates and an information display system acquiring a pointing position as relative coordinates are combined, may be a pointer cursor display method in an information display system having an information processing apparatus, an information display apparatus which displays information held in the information processing apparatus, on a display surface, and a pointing apparatus which points at an arbitrary position on a display image displayed by the information display apparatus; the pointing apparatus performing processing of imaging an arbitrary range by an imaging device included in the pointing apparatus; and the information processing apparatus performing processing of comparing imaged image information at a current point of time and imaged image information temporally preceding the current point of time, as are obtained by imaging a plurality of times, by or without, changing at least one of an imaging position and an imaging angle of the imaging device included in the pointing apparatus, by the imaging device, calculating a pointing coordinate motion vector from a result of the comparison, finding a tentative pointing position of a pointer cursor after being moved, on the basis of the calculated coordinate motion vector, the imaged image information, and the display image information, specifying a pointing position of the pointer cursor after being moved, as pointing coordinates within a range containing the tentative pointing position, and compositing and displaying the pointer cursor to and at the specified pointing coordinates on the display image information corresponding to the display image.

(45) A pointer cursor display method in the information display system of an aspect of the present invention, in which an information display system acquiring a pointing position as absolute coordinates and an information display system acquiring a pointing position as relative coordinates are combined, may well be a pointer cursor display method in an information display system having an information processing apparatus, an information display apparatus which displays information held in the information processing apparatus, on a display surface, and a pointing apparatus which points at an arbitrary position on a display image displayed by the information display apparatus; the pointing apparatus performing processing of comparing imaged image information at a current point of time and imaged image information temporally preceding the current point of time, as are obtained by imaging an arbitrary range a plurality of times, by or without, changing at least one of an imaging position and an imaging angle of an imaging device included in the pointing apparatus, by the imaging device, calculating a pointing coordinate motion vector from a result of the comparison, finding a tentative pointing position of a pointer cursor after being moved, on the basis of the pointing coordinate motion vector, and the display image information corresponding to the display image, and specifying a pointing position of the pointer cursor after being moved, as pointing coordinates within a range containing the tentative pointing position; and the information processing apparatus performing processing of compositing and displaying the pointer cursor to and at the specified pointing coordinates on the display image information.

(46) In the pointer cursor display method in the information display system as defined in any of the above described (43) through (45), the pointing coordinate specification process is permitted by setting the range with reference to the tentative pointing position, computing correlations at respective positions by performing pattern matching between the imaged image and the display image information at the imaging point of time within the set range, and specifying the pointing coordinates after the motion, on the basis of the computed correlations.

Also in the pointer cursor display method in the information display system in each of the above described (43), (44) and (45), the contents defined in the above described (15), (16) and (30) can be applied.

As thus far described, the aspects of the present invention are broadly classified in which a pointing position is acquired as absolute coordinates so as to display a pointer cursor at the acquired coordinate position, in which a pointing position is acquired as relative coordinates so as to display a pointer cursor at the acquired coordinate position, and in which both the preceding are combined.

In an aspect of the invention, the pointer cursor is displayed at the coordinate position acquired as the absolute coordinates, a portable information equipment, having both an imaging function and a communication function, is employed as a pointing apparatus, a range containing that position on a display image which is to be pointed at by the pointing apparatus is photographed, and imaged image information corresponding to the range is outputted to a personal computer (hereinafter “PC”) or the like being an information processing apparatus. In the PC having accepted the imaged image information, which range of display image information corresponding to a current display image the imaged image information corresponds to is decided, the coordinates of the position pointed at by the pointing apparatus are specified as the pointing coordinates from the result of the decision, and the pointer cursor is composited to and displayed at the specified pointing coordinates.

In this manner, in an aspect of the present invention, it is unnecessary to especially provide any of featuring shapes, markers, etc. on the display image, or to simultaneously photograph any featuring image, and merely the imaging may be performed so as to contain the pointing position.

The pointing coordinates are specified by imaging the pointing position with an imaging device, and the pointer cursor generated on the PC side is displayed at the position, so that an “unintentional movement” can be reduced or prevented from occurring in the displayed pointer mark, unlike in a case where a pointing position is pointed at by employing a laser pointer or the like. Specifically, when a user points by employing the laser pointer or the like, a light spot projected on the pointing position, often moves due to the unintentional movement of the hands. In contrast, in an aspect of the present invention, the unintentional movement can be reduced or eliminated by performing an unintentional-movement movement correction process on the PC side or in the pointing apparatus.

The central part of a imagable range set by collimation device, such as the finder or display unit of the imaging device, is used as the pointing position of the pointing apparatus, whereby the pointing position can be set easily and accurately.

A template image is generated from the imaged image information of the range imaged by the pointing apparatus, and the pattern matching between the template image information and the display image information is performed, whereby which part of the whole display image the imaged image corresponds to is decided, and the pointing position is specified using the result of the decision, so that the pointing position can be specified at a high accuracy.

In such a system, the pointing position being acquired as the absolute coordinates, the pointing coordinate specification can be done on the information processing apparatus (PC) side as stated above. But it can also be done on the pointing apparatus side. In this case, a pointing coordinate specification device is included in the pointing apparatus.

An advantage of performing the pointing coordinate specification device on the information processing apparatus (PC) side, is that the pointing apparatus merely transmits the imaged image information to the information processing apparatus, so the quantity of arithmetic operations in the pointing apparatus can be decreased. Moreover, hardware or software (for image processing by way of example) necessary for the pointing coordinate specification need not be installed on the pointing apparatus side. Accordingly, a general portable information equipment can be employed as the pointing apparatus. In addition, since the PC is generally higher in processability than the pointing apparatus, processes such as the coordinate specification can be performed at higher speeds. Even a complicated image processing operation can be performed with ease and at high speed, so that high-precision coordinate specification is realized.

An advantage of performing the pointing coordinate specification device on the pointing apparatus side, is that, when viewed from the PC side, the pointing apparatus can be regarded as a mere device. Specifically, when the display image information is merely transmitted to the device (pointing apparatus), the absolute coordinate information is transmitted from the device. Therefore, any complicated process need not be especially performed on the PC side, it is dispensed with to install any complicated hardware or software for image processing, and the quantity of arithmetic operations on the PC side can be curtailed.

In an aspect of the invention, the pointing position is acquired as the relative coordinates, so as to display the pointer cursor at the acquired coordinate position, imaged image information at the current point of time and imaged image information in a frame temporally preceding the current point of time are compared. A pointing coordinate motion vector is calculated from the result of the comparison. The pointing coordinate motion vector is outputted to a PC. The PC composites a pointer cursor displayed at the current point of time, to display image information corresponding to a display image displayed at the current point of time and then displays the pointer cursor at a position which is distant in correspondence with the pointing coordinate motion vector calculated by a pointing apparatus.

In the case of acquiring the pointing position as the relative coordinates, an image to be imaged by the pointing apparatus need not be the display image, so that the limitation of an imaging place can be relieved. Thus, in a case, for example, where many people point at positions in a large presentation hall, the system becomes convenient for use. Moreover, since the pointing apparatus can be used with the feeling of the mouse of the PC, it is also one of characterizing features that a pointing manipulation is easily performed.

In the case of acquiring the pointing position as the relative coordinates, display image information saved on the PC side is not required as information which is necessary for the calculation of the pointing coordinate motion vector to find the relative coordinates, so that the arithmetic operation of the pointing coordinate motion vector calculation can be performed on only the pointing apparatus side.

In this manner, the display image information is not required in performing the pointing coordinate motion vector calculation. This signifies that such processing, such as loading the display image information onto the pointing apparatus side, need not be performed, and that only the pointing coordinate motion vector information calculated by the pointing apparatus may be transmitted onto the information processing apparatus side. Therefore, the image information of large information content need not be exchanged between the pointing apparatus and the PC, and the communication load between the two can be lightened.

The pointing coordinate motion vector is found by employing the imaging device, and the pointer cursor generated on the PC side is displayed, so that an “unintentional movement” can be reduced or prevented from occurring in the displayed pointer mark, unlike in a case where a pointing position is pointed at by employing a laser pointer or the like. Specifically, when a user points by employing the laser pointer or the like, a light spot projected on the pointing position, often moves due to the unintentional movement of the hands. In an aspect of the present invention, the unintentional movement can be reduced or eliminated by performing an unintentional-movement correction process on the PC side or in the pointing apparatus.

In such a system, the pointing position being acquired as the relative coordinates, the pointing coordinate motion vector calculation can be done on the pointing apparatus side as stated above. But it can also be done on the information processing apparatus (PC) side. In the case where the pointing coordinate motion vector calculation is done on the PC side, a pointing coordinate motion vector calculation device and an imaged image information storage device are included on the PC side.

An advantage of performing the pointing coordinate motion vector calculation on the pointing apparatus side, is that, when viewed from the PC side, the pointing apparatus can be regarded as a mere device. In addition to the advantage already stated that, since only the pointing coordinate motion vector information calculated by the pointing apparatus may be transmitted to the PC side, the image information of large information content need not be exchanged between the pointing apparatus and the PC, so the communication load between the two can be lightened. Specifically, since the relative coordinate information is merely transmitted from the device (pointing apparatus) to the PC, any complicated process need not be especially performed on the PC side. It is dispensed with to install any complicated hardware or software for image processing, and the quantity of arithmetic operations on the PC side can be curtailed.

An advantage of performing the pointing coordinate motion vector calculation on the information processing apparatus (PC) side, is that the pointing apparatus merely transmits the imaged image information to the information processing apparatus, so the quantity of arithmetic operations in the pointing apparatus can be reduced. Moreover, it is not required to install hardware or software necessary to calculate the pointing coordinate motion vector, on the pointing apparatus side. Accordingly, a general portable information equipment can be employed as the pointing apparatus. In addition, since the PC is generally higher in processability than the pointing apparatus, the pointing coordinate motion vector calculation process can be performed at a higher speed, so that the calculation of a high-precision pointing coordinate motion vector is realized.

Regarding the pointing apparatus for use in each of the above aspects of the invention, a camera built-in type portable telephone, a digital still camera, a digital video camera, or the like can be employed as a portable information equipment having an imaging function and a communication function. When, among them, a camera built-in type portable information equipment (especially, portable telephone) is employed, the system becomes more convenient to use. Specifically, the camera built-in type portable telephone is in wide use, and it is excellent in the aspects of functionality and manipulability in such a manner that it originally has a communication function through a network, that it includes a character input interface, and that it is manipulatable with one hand, so the system becomes more convenient for use.

Recently, any desired application can be installed on some of the portable telephones of the specified type. In case of such a portable telephone, therefore, the system can be coped with merely by installing a pointing application, and it is unnecessary to remodel hardware or to create hardware anew for incarnating the present invention. This is also an important characterizing feature.

The aspect of the invention, the acquisition of the pointing coordinates based on the absolute coordinates and the acquisition of the pointing coordinates based on the relative coordinates being combined, as described above in (31) through (46), in that a region where the pattern matching of a display image to a template image is to be performed, is refined using relative coordinate motion vector information found by the motion of a pointing apparatus, and that the pattern matching with the newest imaged image (template image) imaged by an imaging device is performed as to the refined region.

Thus, the pointing position obtained by a process to specify the pointing position based on the relative coordinates is set as a tentative pointing position. A predetermined pattern matching region is set around the tentative pointing position. Thus the pattern matching within the pattern matching region may be performed. As compared with the case of submitting the whole display image to the pattern matching, therefore, the quantity of arithmetic operations required for the pattern matching can be curtailed sharply and the pointing position can be specified at high speed and at high precision.

A pointing coordinate motion vector calculation process is performed on the pointing apparatus side in the aspect of the invention described in (31). But the pointing coordinate motion vector calculation process can also be performed on an information processing apparatus side. This corresponds to an aspect of the invention described in (32). In this case, pointing coordinate motion vector calculation device is disposed on the information processing apparatus side, imaged image information from the pointing apparatus is sent to the pointing coordinate motion vector calculation device on the information processing apparatus side, and a pointing coordinate motion vector is calculated on the information processing apparatus side. The pointing coordinate motion vector calculation process can be performed by the same steps as stated above.

The pointing coordinate specification device specifies pointing coordinates by using the imaged image information from the imaging device on the pointing apparatus side, the pointing coordinate motion vector calculated by the pointing coordinate motion vector calculation device of its own, and a display image at the imaging point of time as stored in display image information storage device.

An advantage of performing the pointing coordinate motion vector calculation on the information processing apparatus side in this manner, is that the pointing apparatus merely transmits the imaged image information to the information processing apparatus, so the quantity of arithmetic operations in the pointing apparatus can be reduced. Moreover, it is not required to install hardware or software necessary to calculate the pointing coordinate motion vector, on the pointing apparatus side. Accordingly, a general portable information equipment can be employed as the pointing apparatus. In addition, since the information processing apparatus is generally higher in processability than the pointing apparatus, the pointing coordinate motion vector calculation process can be performed at a higher speed. Even a complicated image processing operation can be performed with ease and at high speed, so that the calculation of a high-precision pointing coordinate motion vector is realized.

Further, an aspect of the invention described in (32) is such that the pointing coordinate specification device is disposed on the pointing apparatus side so as to perform the processing up to the pointing coordinate specification process on the pointing apparatus side. In this case, the pointing coordinate specification device existing on the pointing apparatus side performs the pointing coordinate specification process by using the imaged image from the imaging device and the pointing coordinate motion vector calculated by the pointing coordinate motion vector calculation device, and further, acquiring the display image from the information processing apparatus side, whereby the specified pointing coordinates are sent to the information processing apparatus side.

An advantage providing the pointing coordinate specification device on the pointing apparatus side so as to perform the processing up to the pointing coordinate specification process on the pointing apparatus side in this manner, is that, when viewed from the PC 1 side, the pointing apparatus can be regarded as a mere device. Specifically, when the display image information is merely transmitted to the device (pointing apparatus), the absolute coordinate information is transmitted from the device. Therefore, any complicated process need not be especially performed on the information processing apparatus side, it is dispensed with to install any complicated hardware or software for image processing, and the quantity of arithmetic operations on the information processing apparatus side can be curtailed.

In the information display system defined in any of the above described (31) through (33) or in the pointer cursor display method in an information display system as defined in any of the above described (43) through (45), the pointing coordinate specification process is such that, while the imaged image is being shifted with a base point being the conjectured position and along a path within a range on a display image at the imaging point of time of the imaged image, the pattern matching between the imaged image and the display image is performed, whereby correlations at respective positions are computed so as to specify the pointing coordinates on the basis of the computed correlations. Thus, the pointing coordinates can be specified efficiently and with accuracy.

In each of the above inventions, a command input device is disposed on the pointing apparatus side, and a command processing device to accept and process a command from the pointing apparatus is disposed on the PC side. Thus, when the command is issued from the command input device of the pointing apparatus, the command is accepted and processed on the PC side, whereby the result of the process can be reflected on the pointing coordinates pointed at by the pointing apparatus.

By way of example, a pointer is permitted to point at an arbitrary position on a display image and to thereafter input a character to the pointing position or correct display contents, with the pointing apparatus, and it becomes possible, not only to point at the pointing position, but also to perform the operations of editing and correcting the display contents. This signifies that the remote control of the computer is also realized.

### BRIEF DESCRIPTION OF THE DRAWINGS

FIG. 1 is a schematic to explain the first exemplary embodiment of the present invention;

FIG. 2 is a schematic to explain an example in which a pointing position in the first exemplary embodiment is acquired as absolute coordinates;

FIG. 3 is a flow chart to explain the steps of a pointed/pointing coordinate specification process in the first exemplary embodiment;

FIG. 4 is a flow chart to explain a process in which a pointer cursor is composited on a display image in the first exemplary embodiment;

FIG. 5 is a schematic to explain the second exemplary embodiment of the present invention;

FIG. 6 is a schematic to explain an example in which a pointing position in the second exemplary embodiment is acquired as relative coordinates;

FIG. 7 is a flow chart to explain the steps of a pointing coordinate motion vector calculation process in the second exemplary embodiment;

FIG. 8 is a schematic to explain a specific example of the pointing coordinate motion vector calculation process in FIG. 7;

FIG. 9 is a flow chart to explain a process in which a pointer cursor is composited on a display image, in the second exemplary embodiment;

FIG. 10 is a schematic to explain the third exemplary embodiment of the present invention;

FIG. 11 is a schematic to explain a pointing coordinate specification process in the third exemplary embodiment;

FIG. 12 is a schematic to explain an example of a pointing manipulation with a pointing apparatus (camera built-in type portable telephone) in the third exemplary embodiment;

FIG. 13 is a schematic to explain an operating example of pattern matching for specifying pointing coordinates in the third exemplary embodiment;

FIG. 14 is a schematic to explain the fourth exemplary embodiment of the present invention, in which a pointing position is acquired as absolute coordinates, and a command is thereafter executable on the pointing coordinates;

FIG. 15 is a schematic showing an example in which a command is inputted, and the execution result of a process complying with the command is displayed at a pointing coordinate position;

FIG. 16 is a view showing another example in which a command is inputted, and the execution result of a process complying with the command is displayed at a pointing coordinate position; and

FIG. 17 is a schematic to explain the fourth exemplary embodiment of the present invention, and to make possible to acquire a pointing position as relative coordinates and to thereafter execute a command on the pointing coordinates.

### DETAILED DESCRIPTION OF PREFERRED EMBODIMENTS

Now, exemplary embodiments of the present invention will be described. In the exemplary embodiments, it is assumed to employ a projector as an image display apparatus. There will be described an example in which the projector is connected to a PC being an information processing apparatus, whereby data from the PC is projected on a wall or screen by the projector, and in which an arbitrary position is pointed/pointing for a projected image by a pointing apparatus, so as to acquire the coordinate information of the pointed/pointing position and to display a pointer cursor on the corresponding coordinates.

As the pointing apparatus, it is assumed to employ a portable information equipment which has an imaging function of picking up and taking an image, and a communication function capable of transmitting image information thus obtained, to a network or PC (for example, a camera built-in type portable telephone, a digital still camera having the communication function, or a digital video camera having the communication function).

The present invention may be capable of acquiring a pointing position as absolute coordinates and/or as relative coordinates. Therefore, an example in which the pointing position is acquired as the absolute coordinates will be described as the first exemplary embodiment, an example in which the pointing position is acquired as the relative coordinates will be described as the second exemplary embodiment, and an example in which pointing coordinates are specified by combining both the coordinates will be described as the third exemplary embodiment. Further, it is permitted to input a command on the coordinate position pointed at, and a process in which the inputted command is executed on a PC so as to reflect the result of the execution at the acquired coordinate position will be described as the fourth exemplary embodiment.

### First Exemplary Embodiment

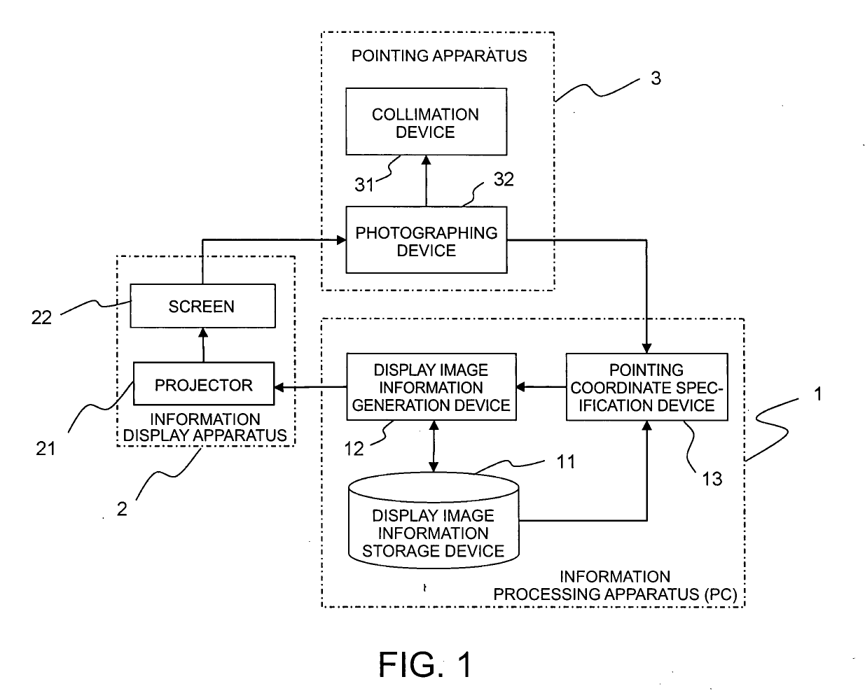

FIG. 1 is a schematic showing constituents which are necessary to explain this exemplary embodiment. When broadly classified, the constituents include a PC 1 which is an information processing apparatus, an information display apparatus 2 which displays information outputted from the PC 1, and a pointing apparatus 3 which points at an arbitrary position on an image displayed by the information display apparatus 2.

The pointing apparatus 3 is assumed to employ the portable information equipment having the imaging function and the communication function as stated above, such as the camera built-in type portable telephone, the digital still camera having the communication function, or the digital video camera having the communication function.

The PC 1 includes a display image information storage device 11 to store therein the image information of images which are to be displayed, a display image information generation device 12 having the functions of generating image information which is to be displayed at the current point of time, and compositing a pointer cursor at the coordinate position pointed at on the display image, and a pointing coordinate specification device 13 to specify coordinates pointed at by the pointing apparatus 3 (coordinates at which the pointer cursor is to be displayed).

The information display apparatus 2 is constructed of a projector 21 which projects image information, and a screen 22 on which the image information is projected.

The pointing apparatus 3 includes a collimation device 31, such as a finder or display screen, which is usually included in the above-mentioned portable information equipment having the imaging function, and an imaging device 32 to take an image in a range set by the collimation device 31. Information from the pointing apparatus 3 can be transmitted to the PC 1 by any communication device, such as a wireless LAN, or a network utilizing infrared transmission or telephone lines.

In such a construction, there will be described a specific operation to display the pointer cursor at the position pointed at by the pointing apparatus 3.

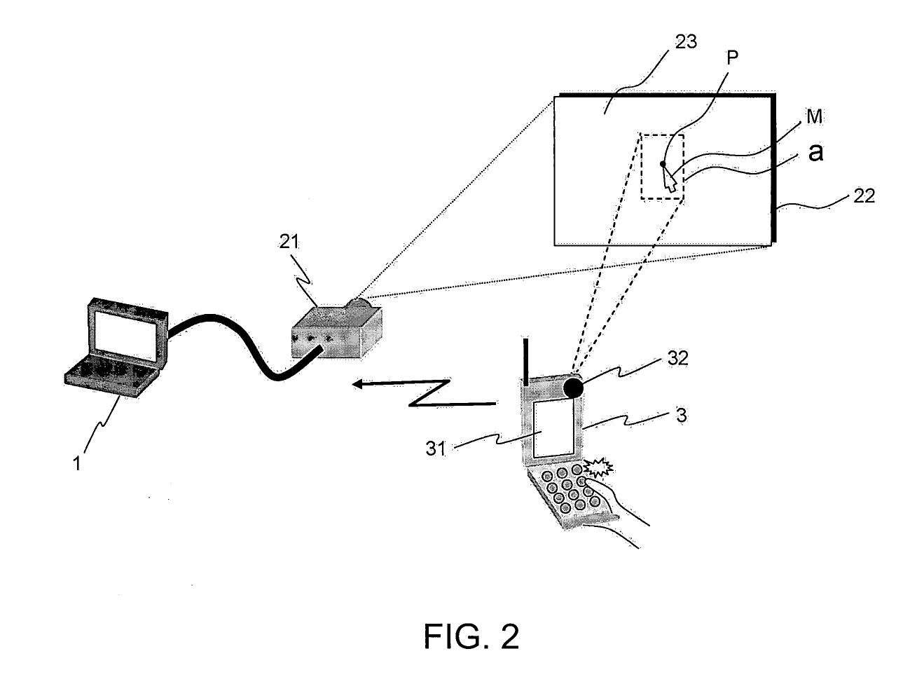

The display image information stored in the display image information storage device 11 of the PC 1 is read out by the manipulation of an operator who operates the PC 1. The image information read out is subjected by the display image information generation device 12 to a display image information generation process which makes possible the display process of the image information by the projector 21, whereupon the processed image information is sent to the projector 21 and is projected on the screen 22 (refer to FIG. 2) or the like by this projector 21.

FIG. 2 shows an example in which an arbitrary position on a display image 23 projected by the projector 21 is pointed at by the pointing apparatus 3. In the example of FIG. 2, this device is assumed to be a camera built-in type portable telephone, to which the reference numeral “3” is also assigned. As seen also from FIG. 2, the operator images with the camera built-in type portable telephone 3 so as to contain the arbitrary position P (indicated by a black circle in the figure) on the display image 23 projected on the screen 22.

The arbitrary position P is a position at which the pointing cursor is to be displayed on the display image 23 projected on the screen 22, and it shall be termed the “pointing position P” below. The pointing position P is brought to the central part of a imagable range which is set by the collimation device of the camera built-in type portable telephone 3 (in this case, the display screen 31 of the camera built-in type portable telephone 3). A broken-line frame “a” indicated on the display image 23 is the imagable range set by the display screen 31 of the camera built-in type portable telephone 3 (in general, the display range of the display screen), and the range enclosed with the broken-line frame “a” becomes a range which can be imaged by imaging one time.

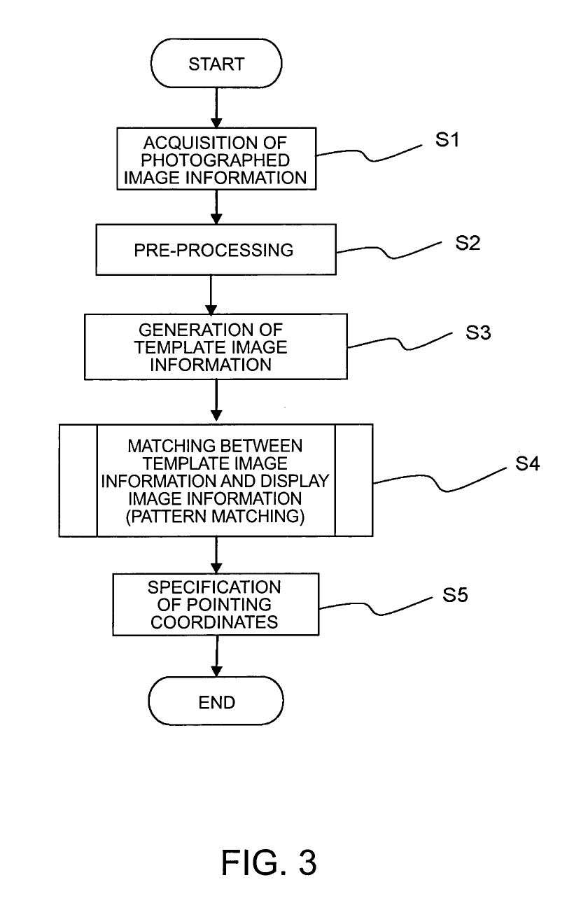

In this way, the pointing position P is imaged in the state where it is positioned at the central part of the display screen 31, specifically, the imagable range “a”, by using the imaging function of the camera built-in type portable telephone 3. Then, the imaged image information is transmitted to the PC 1 through communication device. Thus, in the PC 1, pointing coordinates are specified in accordance with steps as shown in the flow chart of FIG. 3, by the pointing coordinate specification device 13.

FIG. 3 shows the steps of a pointing coordinate specification process which the pointing coordinate specification device 13 of the PC 1 performs. When the imaged image information transmitted from the camera built-in type portable telephone 3 is acquired (step S1), various correction processing for distortion, brightness, etc., and further, various pre-processing, such as scale-up/scale-down, are first performed (step S2), and template image information is generated from the pre-processed imaged image information (step S3). The template image information has a resolution which is suited to examine the matching thereof with display image information by the pre-processing that is performed at the step S2.

Subsequently, it is decided which part of the whole display image displayed on the screen 22 the template image information corresponds to. The decision processing is performed by applying image recognition technology, such as the pattern matching between the template image information and the display image information, corresponding to the display image displayed at the imaging point of time, among the display image information stored in the display image information storage device 11 (step S4).

When it is decided which part of the display image information corresponding to the display image displayed at the imaging point of time the template image information corresponds to, coordinates corresponding to the pointing position P are specified as the pointing coordinates, under the assumption that the central part of the decided part be the pointing position P (step S5).

When, in this way, the pointing coordinates corresponding to the pointing position P are obtained by the pointing coordinate specification device 13, the pointer cursor M (refer to FIG. 2) is composited and displayed on the pointing coordinates. Thus, the pointer cursor M generated on the PC 1 is displayed at the user's pointing position P on the display image 23 projected on the screen 22.

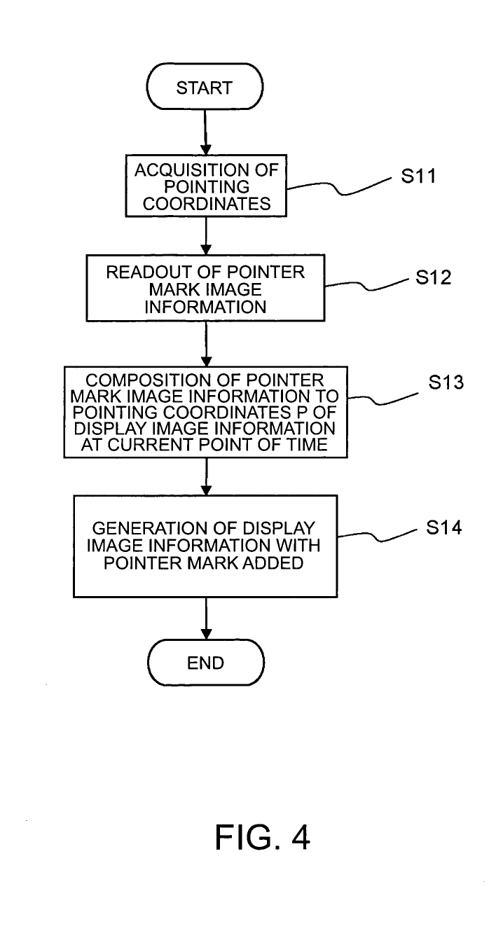

FIG. 4 is a flow chart for explaining the steps of a process in which the pointer cursor M is displayed at the pointing position P on the display image 23 projected on the screen 22. When the pointing coordinates are specified by the above process shown in FIG. 3, the pointing coordinates are acquired (step S11), and pointer cursor image information is read out from a pointer cursor image information holding portion in which the pointer cursor image information is held (in this example, the pointer cursor image information is assumed to be held in the display image information storage device 11) (step S12).

Subsequently, the pointer cursor image information read out is composited to the coordinates (pointing coordinates specified in FIG. 3) of the display image information corresponding to the display image at the imaging point of time (step S113), and display image information with the pointer cursor information composited to the pointing coordinates is generated (step S14).

Thus, in the display image 23 projected on the screen 22, the pointer cursor M is displayed at the pointing position P pointed at by the camera built-in type portable telephone 3.

In this manner, in a case where a certain specified position is to be pointed at on the display image 23 projected on the screen 22, the pointer cursor M can be displayed at the pointing position P of the display image, merely in such a way that the position to be pointed at (pointing position P) is brought to the center of the collimation device (display screen) 31 of the camera built-in type portable telephone 3, and that the image of the corresponding part is taken by the portable telephone 3.

The above exemplary embodiment has been described on the example in which the camera built-in type portable telephone is employed as the pointing apparatus 3. Of course, however, the present invention is not restricted to the camera built-in type portable telephone, but it can be similarly performed with a digital still camera having a communication function, a digital video camera having a communication function, or the like. The foregoing exemplary embodiment has been described using the example in which the pointer cursor image information is held in the display image information storage device 11 of the PC 1. It is also allowed, however, that the pointer cursor image information be held in another place (for example, on the pointing apparatus 3 side), and that the pointer cursor image information be read out from the holding place and be transferred to the PC 1.

In this manner, in the first exemplary embodiment, the range which contains the position to be pointed at by the pointing apparatus 3 may be imaged by the pointing apparatus 3. It is dispensed with to display any featuring shape or the like on a display image as in the related art. Moreover, the specification of the pointing coordinates in the first exemplary embodiment is determined by the pattern matching between the template image information obtained by the imaging with the pointing apparatus 3 and the display image information corresponding to the display image projected on the screen 22. Therefore, it is also one of the characterizing features of an aspect of the present invention that the detection accuracy of the pointing coordinates is high.

The first exemplary embodiment has been described using the example in which the pointing coordinate specification device 13 is disposed on the PC 1 side so as to perform the pointing coordinate specification process on the PC 1 side. However, the pointing coordinate specification device 13 may well be disposed on the pointing apparatus 3 side so as to perform the pointing coordinate specification process on the pointing apparatus 3 side. In this case, the pointing coordinate specification device 13 of the pointing apparatus 3 reads out the display image displayed at the imaging point of time, from the display image information storage device 11 on the PC 1 side, performs the pointing coordinate specification process for the display image, and sends the pointing coordinates thus specified, to the PC 1 side (display image information generation device 12).

In this manner, the pointing coordinate specification process can also be performed on the pointing apparatus 3 side, not on the PC 1 side.

An advantage of, as already stated, providing the pointing coordinate specification device 13 on the PC 1 side so as to perform the pointing coordinate specification process on the PC 1 side, is that the pointing apparatus 3 merely transmits the imaged image information to the PC 1, so the quantity of arithmetic operations in the pointing apparatus 3 can be decreased. Moreover, hardware or software necessary for the pointing coordinate specification need not be installed on the pointing apparatus 3 side. Accordingly, a general portable information equipment can be employed as the pointing apparatus 3. In addition, since the PC 1 is generally higher in processability than the pointing apparatus 3, processes, such as the coordinate specification can be performed at higher speeds, and even a complicated image processing operation can be performed with ease and at high speed, so that high-precision coordinate specification is realized.

An advantage of providing the pointing coordinate specification device 13 on the pointing apparatus 3 side so as to perform the pointing coordinate specification process on the pointing apparatus 3 side, is that, when viewed from the PC 1 side, the pointing apparatus 3 can be regarded as a mere device. Specifically, when the display image information is merely transmitted to the device (pointing apparatus 3), the absolute coordinate information is transmitted from the device. Therefore, any complicated process need not be especially performed on the PC 1 side, it is dispensed with to install any complicated hardware or software for image processing, and the quantity of arithmetic operations on the PC 1 side can be curtailed.

### Second Exemplary Embodiment

The second exemplary embodiment is an example in which a pointing position is acquired as relative coordinates. Also this exemplary embodiment will be described on the example in which, as in the first exemplary embodiment, a projector 21 constituting an image display apparatus is connected to a PC 1, data on the PC 1 are projected on a screen 22 by the projector 21, an arbitrary position is pointed/pointing by a pointing apparatus 3 for a display image 23 projected on the screen 22, and a pointer cursor M is displayed at the pointed/pointing position.

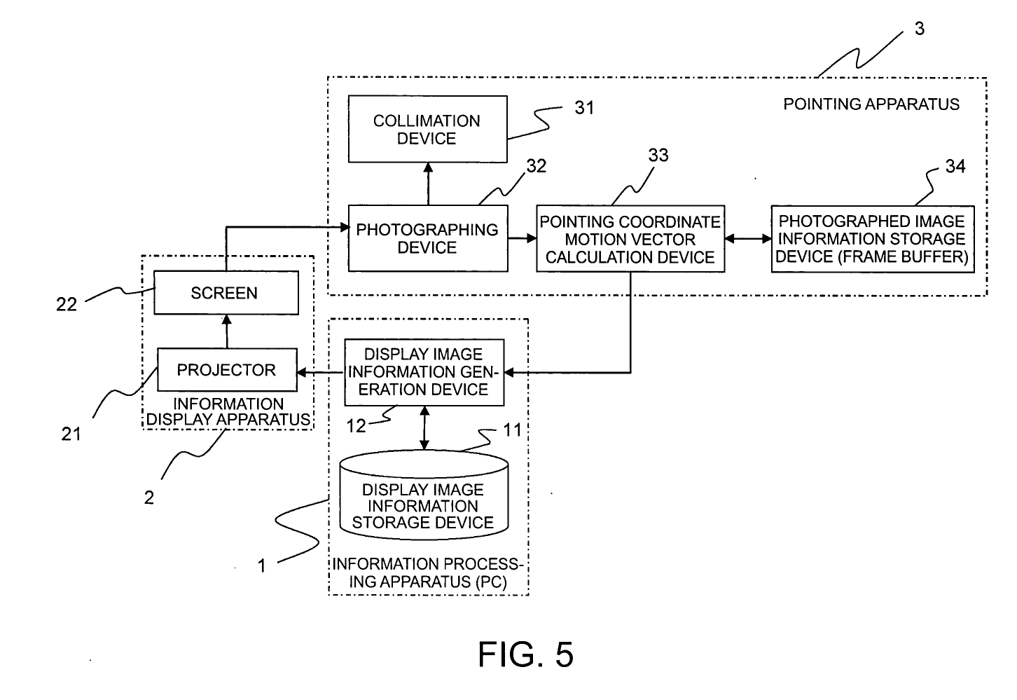

FIG. 5 is a schematic showing constituents which are necessary for explaining this second exemplary embodiment. When broadly classified, the constituents include a PC 1, a projector 21 connected to the PC 1, and a pointing apparatus 3 to point at an arbitrary position on a display image projected by the projector 21, similar to those of the first exemplary embodiment. Also in the second exemplary embodiment, the pointing apparatus 3 will be explained as being the camera built-in type portable telephone 3.

In the second exemplary embodiment, the PC 1 includes a display image information storage device 11 to store therein the image data of images which are to be displayed, and a display image information generation device 12 having the functions of generating image data which is to be displayed at the current point of time, and compositing a pointer cursor M at a position pointed at on a display image 23.

The pointing apparatus 3 includes a collimation device (in this case, the display screen of the camera built-in type portable telephone 3) 31, an imaging device 32 to take the image of a imagable range set by the collimation device 31, pointing coordinate motion vector calculation device 33 to calculate a pointing coordinate motion vector, and an imaged image information storage device 34 being a frame buffer in which a featuring image obtained from an imaged image for one frame is stored. Information from the pointing apparatus 3 can be transmitted to the PC 1 by any communication device, such as a wireless LAN, or a network utilizing infrared transmission or telephone lines.

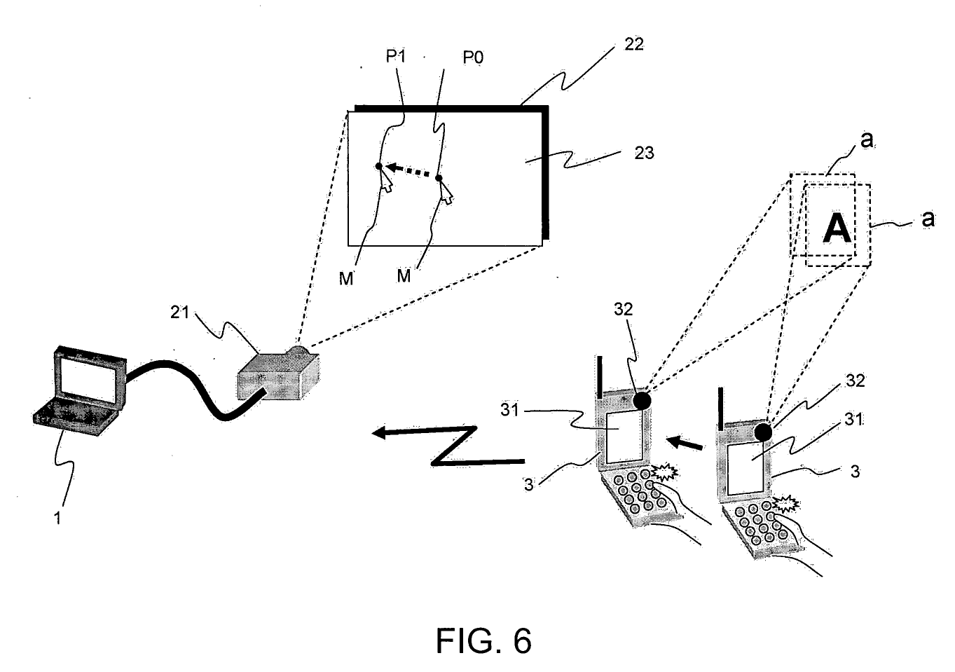

Since the second exemplary embodiment is of a scheme in which a pointing position is acquired as relative coordinates, it suffices to acquire a moving direction/a movement magnitude in/by which the pointing apparatus 3 has been moved (pointing coordinate motion vector). Therefore, the camera built-in type portable telephone 3 may well photograph any place, for example, a place which lies outside the display image 23 projected on a screen 22, as shown in FIG. 6.

Next, the specific pointing operation of the second exemplary embodiment will be described. It is assumed that a certain one of display image information stored in the display image information storage device 11 of the PC 1 be sent to the projector 21, and that the corresponding display image 23 be projected on the screen 22.

In this state, an arbitrary place (which may well lie outside the display image 23 as shown in FIG. 6) is first imaged using the imaging function of the camera built-in type portable telephone 3. On this occasion, the pointer cursor M is assumed to be displayed at, for example, a central part within the display image 23 as its initial position (denoted by P0).

Subsequently, the next frame is imaged by the camera built-in type portable telephone 3 and is compared with the last frame imaged immediately before, so as to compute the moving direction/movement magnitude of the portable telephone 3. The pointing coordinate motion vector is calculated by the pointing coordinate motion vector calculation device 33. Pattern matching, to be explained later, or the technology of motion detection as is employed in MPEG (Motion Picture Expert Group) or the like, can be applied to the calculation of the pointing coordinate motion vector.

On the basis of the calculated pointing coordinate motion vector, the pointer cursor M displayed on the display image 23 is displayed at a position which is distant from the current position (in this case, the initial position P0) in correspondence with the pointing coordinate motion vector. That is, referring to FIG. 6, the pointer cursor M having been at the initial position P0 is displayed at a position P1 which is distant from the initial position P0 in correspondence with the calculated pointing coordinate motion vector.

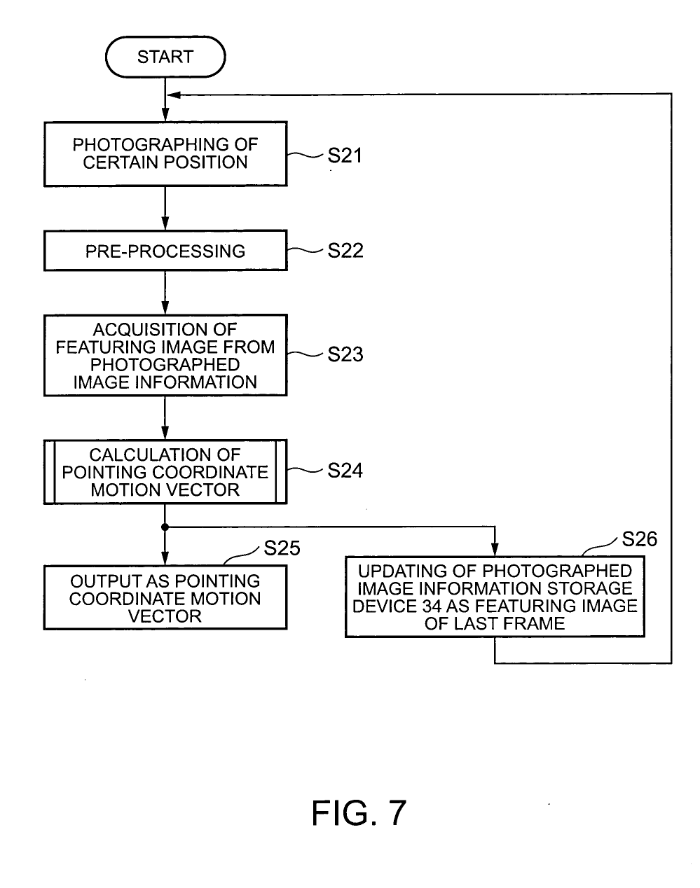

FIG. 7 is a flow chart for explaining a pointing coordinate motion vector calculation process which is executed by the pointing coordinate motion vector calculation device 33 stated above. Referring to FIG. 7, a certain position is first imaged by the pointing apparatus 3 (here, the camera built-in type portable telephone 3) (step S21), correction processing for distortion, brightness, etc., and further, a binarization process for featuring point extraction, etc. are performed as pre-processing for the imaged image (step S22) and any featuring point is extracted from the imaged image completed with the pre-processing, so as to acquire a featuring image (step S23).

Subsequently, the acquired featuring image is compared with a featuring image in the last frame as is held in the imaged image information storage device 34, so as to calculate a pointing coordinate motion vector (step S24). The calculated pointing coordinate motion vector is outputted as a new pointing coordinate motion vector (step S25), while at the same time, the above featuring image acquired at the step S23 is written into the imaged image information storage device 34 as a new featuring image in the last frame, thereby to update the featuring image (step S26). If the motion of the pointing apparatus (in this case, the camera built-in type portable telephone) 3 is continuing, the routine returns to the step S21.

When, in this way, the pointing coordinate motion vector has been calculated by the pointing coordinate motion vector calculation device 33, the pointer cursor M is displayed at a position which is distant in correspondence with the calculated pointing coordinate motion vector.

In a case where an imaged image taken with the camera built-in type portable telephone 3 is the first imaged image, and where any featuring image in the last frame has not been acquired, a featuring image obtained from the first imaged image is saved in the imaged image information storage device 34, and the second and succeeding imaging operations are waited for. When a featuring image is acquired by the second photographing, it is compared with the featuring image of the last frame held in the featuring image information storage device 34 (the featuring image obtained from the first imaged image), so as to calculate a pointing coordinate motion vector, and the featuring image acquired by the second imaging is written into the imaged image information storage device 34 as the featuring image of the last frame, thereby to update stored contents.

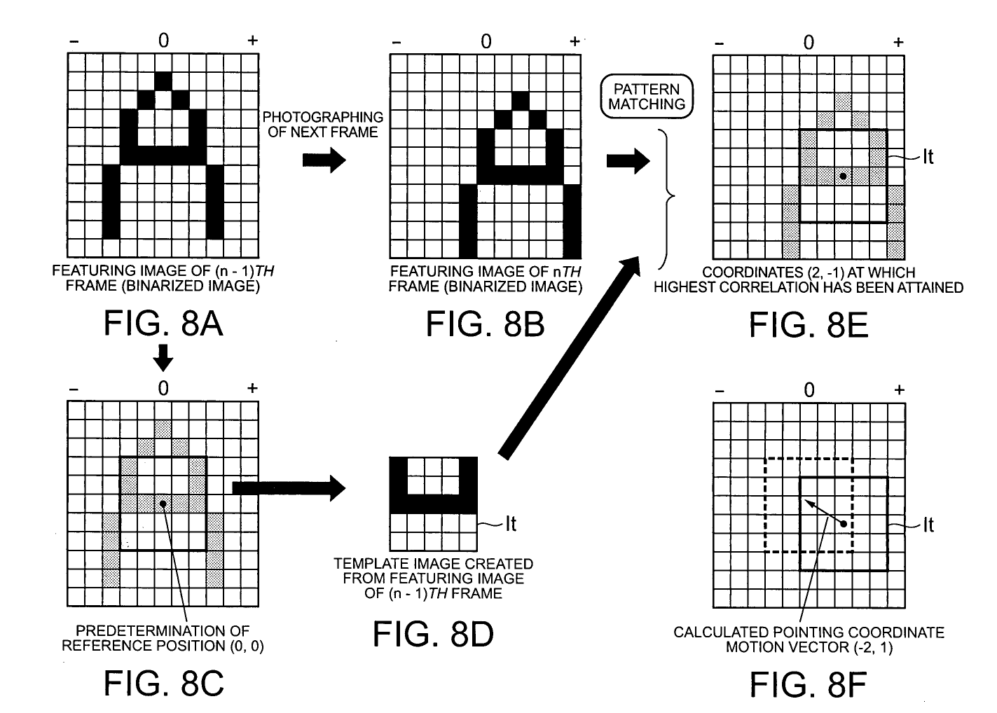

A specific example of the above process explained in the flow chart of FIG. 7 will be described with reference to FIGS. 6 and 8.

First, a certain position (here, a certain position outside the screen 22) is imaged by the camera built-in type portable telephone 3 as shown in FIG. 6 by way of example. Incidentally, it is assumed that the letter “A” happens to exist at the position. The imaging is done so that the letter “A” may be positioned at the center of a imagable range (indicated by a broken-line frame “a” in the figure) set by the collimation device 31 (display screen 3) of the camera built-in type portable telephone 3. It is assumed that, when the imaged image (which is supposed to be the imaged image of the (n −1)th frame) is subjected to pre-processing (such as binarization), a featuring image as shown in FIG. 8A be obtained.

Subsequently, the same letter “A” is imaged at a position where the camera built-in type portable telephone 3 has been moved in an obliquely left upward direction as shown in FIG. 6. On this occasion, since the camera built-in type portable telephone 3 has been moved in the obliquely left upward direction as shown in FIG. 6, the letter “A” comes to a position which shifts in an obliquely right downward direction from the central part of the imagable range (indicated by a broken-line frame “a” in the figure) set by the collimation device 31 (display screen 31) of the camera built-in type portable telephone 3, and an imaged image at the position (supposed to be the imaged image of the nth frame) is acquired. It is assumed that, when the imaged image of the nth frame is subjected to pre-processing as in the foregoing, a featuring image as shown in FIG. 8B be obtained.

The featuring image shown in FIG. 8B is compared with the featuring image of the last frame held in the imaged image information storage device 34 (in this case, the featuring image of the (n−1)th frame), so as to calculate a pointing coordinate motion vector. The process of the pointing coordinate motion vector calculation will be described.

First, a template image It is created from the featuring image of the (n−1)th frame. Specifically an image of, for example, 5 pixels×5 pixels around center coordinates (0, 0), set as a reference, (the image of a range indicated by a thick-line frame in FIG. 8C) is extracted from a featuring image as shown in FIG. 8C (which is the featuring image in FIG. 8A). The extracted image is set as the template image It as shown in FIG. 8D.

The template image It shown in FIG. 8D and the featuring image of the nth frame shown in FIG. 8B are subjected to pattern matching, they are positioned so as to attain the highest correlation (likelihood) (refer to FIG. 8E), and the coordinates of the template image It, relative to the reference coordinates (0, 0), are found in the positioned state. Then, the coordinates of (2, −1) are obtained. The images in FIGS. 8C and E are the same as those in FIGS. 8A and B, respectively. But a black color in FIGS. 8A and B are thinned in FIGS. 8C and E in order to clarify the distinction between the range of the template image It and the featuring images.

In this manner, regarding the reference coordinates which the template image It has been extracted from the featuring image of the (n−1)th frame, the coordinates (2, −1) have been obtained as the center coordinates of the template image It at that position of the template image It at which the highest likelihood has been attained as the result of the pattern matching of the template image It relative to the featuring image of the nth frame. This indicates that shifts of −2 pixels in a lateral direction and+1 pixel in a longitudinal direction exist between the featuring image of the (n−1)th frame and the featuring image of the nth frame, and that the featuring image of the nth frame has moved −2 in a horizontal direction and+1 in a vertical direction relative to the featuring image of the (n−1)th frame. This motion corresponds to a movement magnitude of (−2, 1) in a vectorial representation, and the movement magnitude (−2, 1) becomes the pointing coordinate motion vector which is to be found in this case. That is, in this case, it can be said that, owing to the motion of the camera built-in type portable telephone 3, a frame indicated by a solid line (a frame corresponding to the outer periphery of the template image It) has moved to a position indicated by a broken line as shown in FIG. 8F.

When the pointing coordinate motion vector has been obtained in this way, the pointer cursor M on the display image 23 projected on the screen 22 is displayed at the position P1 which is distant in correspondence with the calculated pointing coordinate motion vector, with the current pointing position P0 being a base point, as shown in FIG. 6.

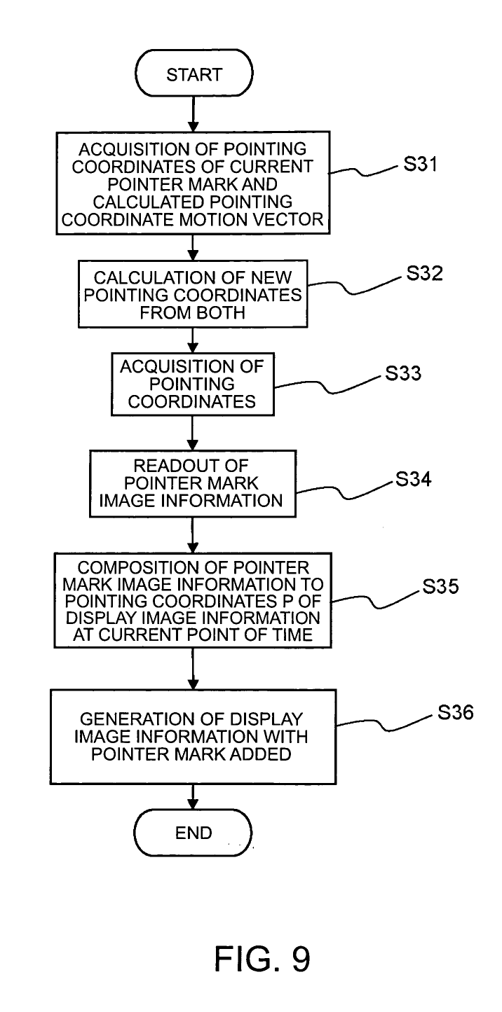

FIG. 9 is a flow chart for explaining the steps of a process in which the pointer cursor M is composited and displayed at the pointing position P1 on the display image 23 projected on the screen 22. When compared with the process in the first exemplary embodiment, as shown in FIG. 4, the process in FIG. 9 additionally contains the processing of finding pointing coordinates at which the pointer cursor M is to be displayed, by using the pointing coordinates at the current point of time and the pointing coordinate motion vector found by the above processing steps described in conjunction with FIG. 7.

Specifically, in the case of acquiring a pointing position as relative coordinates, a vector quantity (the pointing coordinate motion vector) indicating a direction in, and a magnitude by, which the pointer cursor M is to be moved with respect to the current position may merely be found. Therefore, the pointing coordinates of the current pointer cursor M and the calculated pointing coordinate motion vector are first acquired (step S31), and pointing coordinates pointed at a new position are calculated from the acquired current coordinate position and pointing coordinate motion vector (step S32).

When the new pointing coordinates are calculated in this way, they are acquired (step S33). Then, in the same manner as at the steps S12 to S14 in FIG. 4, pointer cursor image information is read out from a pointer cursor image information holding portion (also in this example, the pointer cursor image information is assumed to be held in the display image information storage device 11) (step S34), the pointer cursor image information read out is composited to the pointing coordinates of display image information corresponding to a display image at the current point of time (the pointing coordinates acquired at the step S33) (step S35), and display image information with the pointer cursor M added to the pointing coordinates is generated (step S36).

In this manner, according to the third exemplary embodiment, it suffices to acquire the moving direction/movement magnitude (the pointing coordinate motion vector) in/by which the pointing apparatus 3 (here, assumed to be the camera built-in type portable telephone 3) has been moved. On the pointing apparatus 3 side, therefore, any place different from the display image 23 projected on the screen 22 may be photographed. That is, the pointing apparatus 3 can be used just as a mouse connected to a PC or the like, and the information display system becomes convenient for use. In the case of the second exemplary embodiment, the pointing apparatus 3 may more conveniently be one which is capable of acquiring a moving image, but it may, of course, be a camera which inputs only a still image.

Also the second exemplary embodiment has been described in the example in which the camera built-in type portable telephone is employed as the pointing apparatus 3. Of course, however, the present invention is not restricted to the camera built-in type portable telephone, but it can be similarly performed with a digital still camera having a communication function, a digital video camera having a communication function, or the like.

There has been described the example in which the pointer cursor image information is held in the display image information storage means 11 of the PC 1. As stated in the first exemplary embodiment, however, the pointer cursor image information may well be saved in another place (for example, on the pointing apparatus 3 side), and it can also be read out from the saving place and transferred to the PC 1.

In this manner, according to the second exemplary embodiment, an image to be imaged by the pointing apparatus 3 need not be the display image 23 projected from the projector 21, so that the limitation of an imaging range can be relieved. Thus, in a case, for example, where many people point at positions in a large presentation hall, the information display system becomes convenient for use. Moreover, since the pointing apparatus can be used with the feeling of the mouse of the PC, it is also one of characterizing features that a pointing manipulation is easily performed.

In the case of acquiring a pointing position as relative coordinates, display image information saved on the PC 1 side is not required as information which is necessary for the calculation of a pointing coordinate motion vector to find the relative coordinates, so that the arithmetic operation of the pointing coordinate motion vector calculation can be performed only on the pointing apparatus 3 side.

In this manner, the display image information is not required in performing the pointing coordinate motion vector calculation. This signifies that such processing as loading the display image information onto the pointing apparatus 3 side need not be performed, and that only the pointing coordinate motion vector calculated by the pointing apparatus 3 may be transmitted onto the PC 1 side. Therefore, the image information of large information content need not be exchanged between the pointing apparatus 3 and the PC 1, and the communication load between the two can be lightened.

In the second exemplary embodiment described above, the pointing coordinate motion vector calculation process is performed on the pointing apparatus 3 side, but it can also be performed on the PC 1 side. In this case, the pointing coordinate motion vector is calculated in such a way that the pointing coordinate motion vector calculation device 33 and the imaged image information storage device 34 are disposed on the PC 1 side, and that the imaged image information from the pointing apparatus 3 is sent to the pointing coordinate motion vector calculation device 33. The pointing coordinate motion vector calculation process can be performed by the same steps as stated above.

In this manner, the pointing coordinate motion vector calculation can also be performed on the PC 1 side, not by the pointing apparatus 3.

An advantage of performing the pointing coordinate motion vector calculation on the pointing apparatus 3 side, is that, when viewed from the PC 1 side, the pointing apparatus 3 can be regarded as a mere device, in addition to the advantage already stated that, since only the pointing coordinate motion vector information calculated by the pointing apparatus 3 may be transmitted to the PC 1, the image information of large information content need not be exchanged between the pointing apparatus 3 and the PC 1, so the communication load between the two can be lightened. Specifically, since the relative coordinate information is merely transmitted from the device (pointing apparatus 3) to the PC 1, any complicated process need not be especially performed on the PC 1 side, it is dispensed with to install any complicated hardware or software for image processing, and the quantity of arithmetic operations on the PC 1 side can be curtailed.

An advantage of performing the pointing coordinate motion vector calculation on the PC 1 side, is that the pointing apparatus 3 merely transmits the imaged image information to the PC 1, so the quantity of arithmetic operations in the pointing apparatus 3 can be reduced. Moreover, it is not required to install hardware or software necessary to calculate the pointing coordinate motion vector, on the pointing apparatus 3 side. Accordingly, a general portable information equipment can be employed as the pointing apparatus 3. In addition, since the PC 1 is generally higher in processability than the pointing apparatus 3, the pointing coordinate motion vector calculation process can be performed at a higher speed. Even a complicated image processing operation can be performed with ease and at high speed, so that the calculation of a high-precision pointing coordinate motion vector is realized.

### Third Exemplary Embodiment

The third exemplary embodiment includes the first and second exemplary embodiments described before, whereby the pointing apparatus 3 can specify pointing coordinates in a display image at high speed and at high precision.

Specifically, in specifying the pointing coordinates by the pointing apparatus 3 in the first exemplary embodiment, when imaged image information transmitted from the camera built-in type portable telephone 3 is acquired (step S1), as shown in the flow chart of FIG. 3, various correction processing for distortion, brightness, etc., and further, various pre-processing, such as scale-up/scale-down, are first performed (step S2), and template image information is generated from the pre-processed imaged image information (step S3). Subsequently, which part of the whole display image displayed on the screen 22 the template image information corresponds to, is decided by the pattern matching between the template image information and the display image information corresponding to the display image displayed at the imaging point of time, among the display image information stored in the display image information storage device 11 (step S4).

When it is decided which part of the display image information corresponding to the display image displayed at the imaging point of time the template image information corresponds to, coordinates corresponding to the pointing position P are specified as the pointing coordinates, under the assumption that the central part of the decided part be the pointing position P (step S5).

In this way, the pointing coordinates are specified. In this regard, in the first exemplary embodiment, the pointing coordinate specification process by the pointing coordinate specification device 13 subjects the template image to pattern matching to the whole display image so as to specify the pointing coordinates. In this third exemplary embodiment, however, a region in which pattern matching is to be performed between the template image and the display image is refined using the relative coordinate motion vector information obtained by the motion of the camera built-in type portable telephone 3 as explained in the second exemplary embodiment. The pattern matching between the template image and the display image is performed for the refined region.

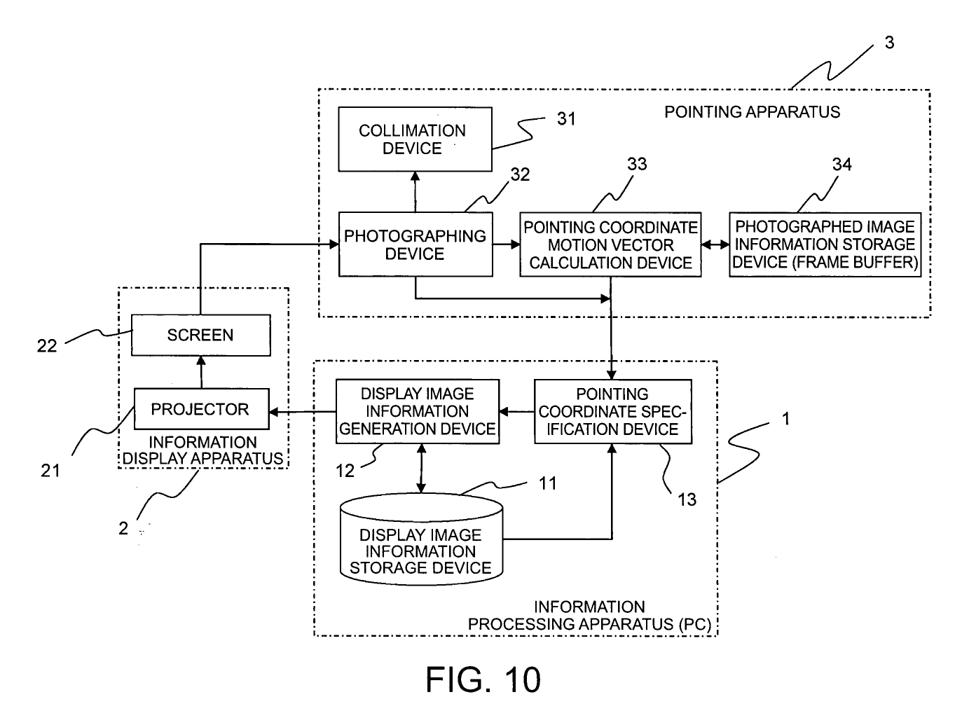

FIG. 10 is a schematic showing constituents which are necessary for explaining this third exemplary embodiment, and is the combination between FIG. 1 used for the description of the first exemplary embodiment and FIG. 5 used for the description of the second exemplary embodiment. That is, a construction shown in FIG. 10 is such that the pointing apparatus 3 in the construction of FIG. 1 is replaced with the pointing apparatus 3 in FIG. 5. Accordingly, an information processing apparatus (PC) 1 includes display image information storage device 11, display image generation device 12 and pointing coordinate specification device 13, as in FIG. 1. A pointing apparatus 3 is constructed including pointing coordinate motion vector calculation device 33 and imaged image information storage device (frame buffer) 34 in addition to collimation device 31 and imaging device 32.

The operation of such a construction will be described. First, it is assumed as in the first and second exemplary embodiments that a certain one of display image information stored in the display image information storage means 11 of the PC 1 be sent to a projector 21, and that the display image 23 of the sent display image information be projected on a screen 22.

In this state, a certain range of the screen 22 is first imaged using the imaging function of the camera built-in type portable telephone 3 (also in this third exemplary embodiment, the pointing apparatus 3 will be explained as the camera built-in type portable telephone 3). Subsequently, the next frame is imaged by the camera built-in type portable telephone 3 and is compared with the last frame imaged immediately before, so as to compute the moving direction/movement magnitude of the portable telephone 3, and a pointing coordinate motion vector is calculated by the pointing coordinate motion vector calculation device 33.

The newest imaged image imaged by the imaging device 32 and the pointing coordinate motion vector information calculated by the pointing coordinate motion vector calculation device 33 are sent to the pointing coordinate specification device 13 of the PC 1. The pointing coordinate specification device 13 specifies pointing coordinates by using the newest imaged image imaged by the imaging device 32, the pointing coordinate motion vector information calculated by the pointing coordinate motion vector calculation device 33, and the display image at the imaging point of time (the point of time of the imaging by the imaging device 32 of the camera built-in type portable telephone 3) as stored in the display image information storage device 11. The operation of the pointing coordinate specification device 13 will be described in detail below.

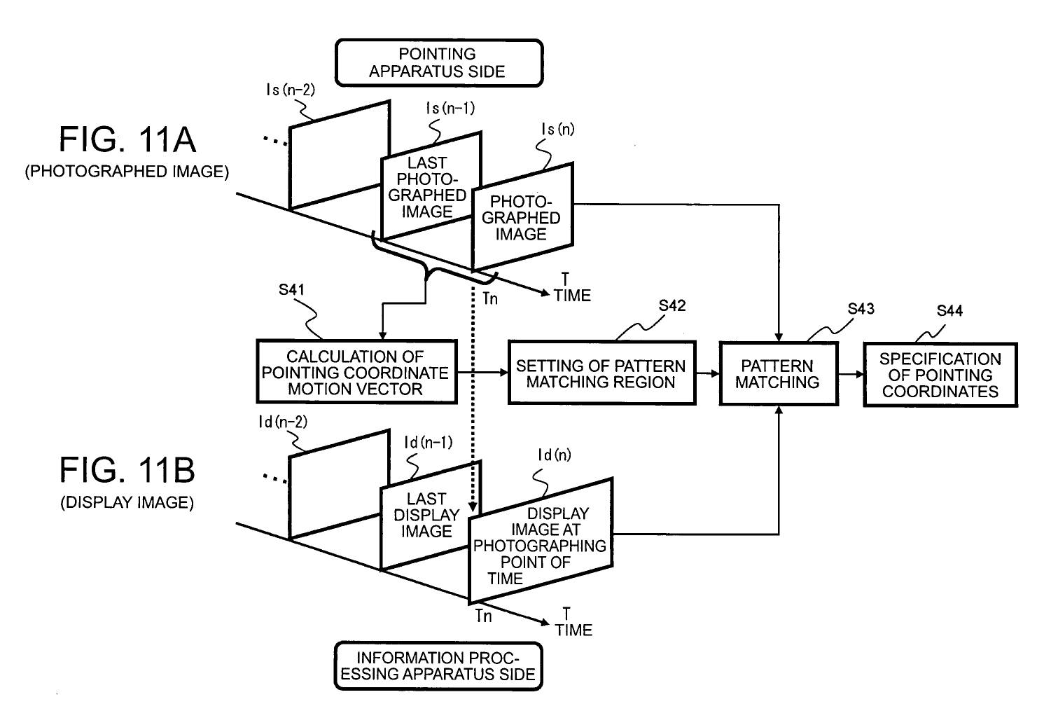

FIG. 11 is a schematic showing a pointing coordinate specification process which the pointing coordinate specification device 13 performs, and (a) represents the change of the imaged image on a time axis T on the camera built-in type portable telephone 3 side, while (b) represents the change of the display image acquired from the display image information storage device 11 on the PC 1 side, on the time axis T.

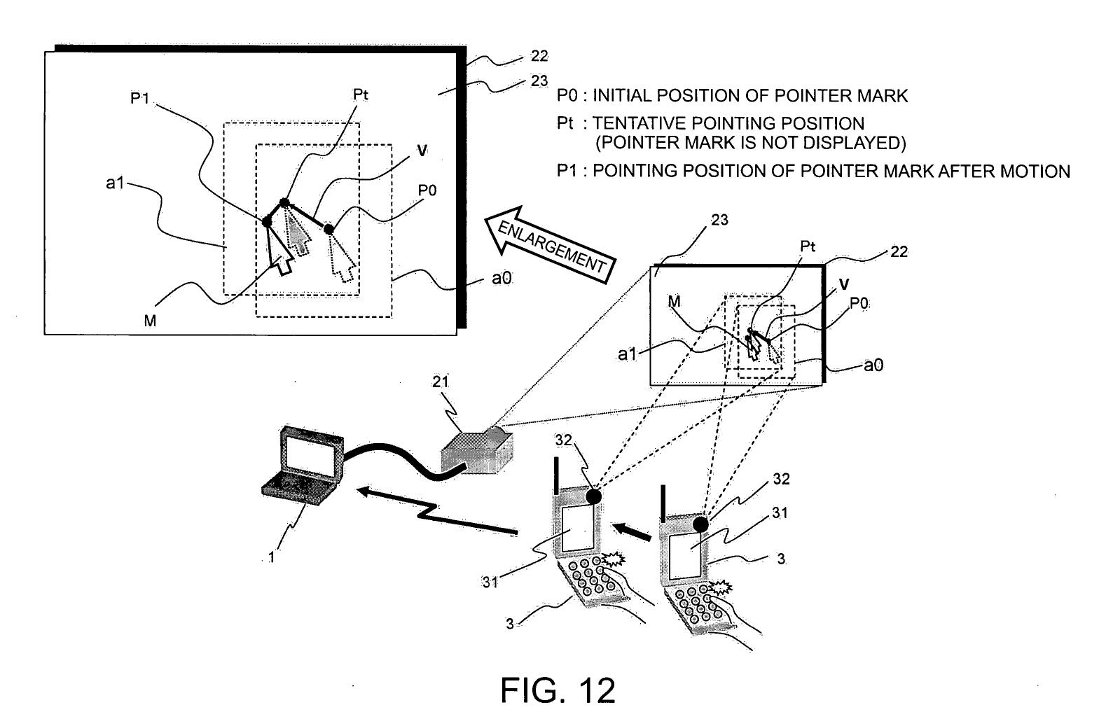

The change of the imaged image of the camera built-in type portable telephone 3 on the time axis T corresponds to that of a user moving the camera built-in type portable telephone 3 in the direction of a broken-line arrow, as shown in FIG. 12, whereby the imagable range of the camera built-in type portable telephone 3 changes along the broken-line arrow (regions a0, a1 enclosed with broken-line frames in FIG. 12). Shown in FIG. 12, is a state where the camera built-in type portable telephone 3 has been moved from an initial position P0 to a final motion position P1 in this case. Specifically, the imaged images of respective frames conforming to the motion of the camera built-in type portable telephone 3 are outputted from the imaging device 32. But only the newest imaged image Is(n) (at a time Tn), the imaged image Is(n−1) of the last frame, and the imaged image Is(n−2) of the second-last frame, are shown in FIG. 11.

Likewise, regarding the display images acquired from the display image information storage device 11 on the PC 1 side, only the newest display image Id(n) (at the time Tn), the last display image Id(n−1), and the second-last display image Id(n−2) are shown in FIG. 11.

In FIG. 11, the newest imaged image (imaged image at the time Tn) is assumed to be the imaged image obtained by imaging in the state where the camera built-in type portable telephone 3 has been moved to the final motion position P1 in FIG. 12.

In the pointing coordinate motion vector calculation device 33, a pointing coordinate motion vector (which is denoted as the pointing coordinate motion vector V) is calculated from a plurality of temporally successive imaged images obtained from the imaging device 32, as described in the second exemplary embodiment (step S41 in FIG. 11). The pointing position (which is called “tentative pointing position Pt” in the third exemplary embodiment) of a pointer cursor M is found on the basis of the calculated pointing coordinate motion vector V.

The tentative pointing position Pt is a position which is distant in correspondence with the pointing coordinate motion vector V from the initial position P0. In this third exemplary embodiment, the tentative pointing position Pt is not the actual display position of the pointer cursor M. But the tentative pointing position Pt is first found, and the final pointing position is determined on the basis of the tentative pointing position Pt.

When the tentative pointing position Pt has been found, a region in which pattern matching is performed is refined, and the refined region is set as a pattern matching region (step S42). That is, a predetermined range centering around the tentative pointing position Pt is set, and the set predetermined range is used as the pattern matching region. Subsequently, the pattern matching between the imaged image and the display image at the imaging point of time of this imaged image is performed in the pattern matching region (step S43). Further, pointing coordinates are specified on the basis of the result of the pattern matching (step S44).

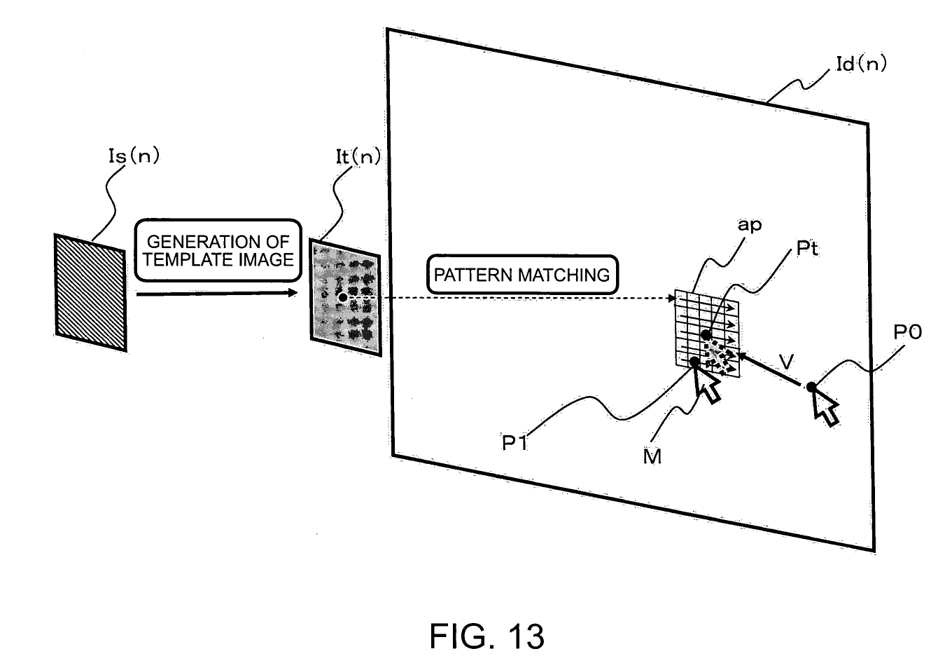

Next, the process to specify the pointing coordinates as based on the pattern matching result will be described with reference to FIG. 13.

As explained before, the pointing coordinate motion vector V is calculated from the plurality of temporally successive imaged images obtained from the imaging device 32, and the tentative pointing position Pt of the pointer cursor M is found on the basis of the calculated pointing coordinate motion vector V. A pattern matching region ap is set with reference to the tentative pointing position Pt. In FIG. 13, a range which includes 5 pixels vertically and 5 pixels laterally around the point Pt is schematically represented as the region ap. The area of the pattern matching region ap, etc. can be variously set otherwise than in this example.

A template image It(n) is generated from the imaged image Is(n) obtained by the imaging device 32 of the camera built-in type portable telephone 3 (as indicated by a hatched rectangle in FIG. 13), by the same expedient as the processing indicated by the steps S2 and S3 in FIG. 3 referred to in the description of the first exemplary embodiment.

Subsequently, the pattern matching operations between the template image It(n) and the display image Id(n) at the imaging point of time of the imaged image Is(n) are performed at the respective positions of the individual pixels in the pattern matching region ap centering around the tentative pointing position Pt found before.

When the pattern matching process has ended in the set pattern matching region ap, that position of the pixel which exhibits the highest correlation thus far found is acquired as coordinates, the coordinates are determined as the pointing position to-be-found (which is denoted by the pointing position P1), and the pointer cursor M is moved to and displayed at the pointing position P1.

Shown in FIG. 13 is an example in which the pointing position P1 exists at the left and obliquely lower position of the tentative pointing position Pt, and the pointer cursor M is displayed at the pointing position P1.

As described above, in specifying the pointing position based on the absolute coordinates as explained in the first exemplary embodiment, the pointing position is specified by subjecting the imaged image to the pattern matching to the whole display image. However, according to the third exemplary embodiment, the specification process for the pointing position based on the relative coordinates as explained in second exemplary embodiment is conjointly used, whereby the pointing position obtained by the pointing position specification process based on the relative coordinates is found as the tentative pointing position, and the pattern matching region is set around the tentative pointing position, whereupon the pattern matching in the pattern matching region may be performed. As compared with the case of the pattern matching to the whole display image, therefore, the third exemplary embodiment can sharply reduce the quantity of arithmetic operations required for the pattern matching and can specify the pointing position at high speed and at high precision.

Also the third exemplary embodiment has been described in the example in which, as in the first and second exemplary embodiments explained before, the camera built-in type portable telephone is employed as the pointing apparatus 3. Of course, however, the present invention is not restricted to the camera built-in type portable telephone, but it can be similarly performed with a digital still camera having a communication function, a digital video camera having a communication function, or the like. There has been described the example in which the pointer cursor image information is held in the display image information storage device 11 of the PC 1. As stated in the first exemplary embodiment, however, the pointer cursor image information may well be saved in another place (for example, on the pointing apparatus 3 side), and it can also be read out from the saving place and transferred to the PC 1.

In the third exemplary embodiment, the pointing coordinate motion vector calculation process is performed on the pointing apparatus 3 side, but it can also be performed on the PC 1 side, as described in the second exemplary embodiment. In this case, the pointing coordinate motion vector is calculated in such a way that the pointing coordinate motion vector calculation device 33 and the imaged image information storage device 34 are disposed on the PC 1 side, and that the imaged image information from the pointing apparatus 3 is sent to the pointing coordinate motion vector calculation device 33. The pointing coordinate motion vector calculation process can be performed by the same steps as explained above.

The pointing coordinate specification device 13 specifies the pointing coordinates by using the imaged image information from the imaging device 32, the pointing coordinate motion vector calculated by the pointing coordinate motion vector calculation device 33, and the display image at the imaging point of time as stored in the display image information storage device 11.

An advantage of performing the pointing coordinate motion vector calculation on the PC 1 side in this manner, is that the pointing apparatus 3 merely transmits the imaged image information to the PC 1, so the quantity of arithmetic operations in the pointing apparatus 3 can be reduced. Moreover, it is not required to install hardware or software necessary to calculate the pointing coordinate motion vector, on the pointing apparatus 3 side. Accordingly, a general portable information equipment can be employed as the pointing apparatus 3. In addition, since the PC 1 is generally higher in processability than the pointing apparatus 3, the pointing coordinate motion vector calculation process can be performed at a higher speed. Even a complicated image processing operation can be performed with ease and at high speed, so that the calculation of a high-precision pointing coordinate motion vector is realized.

Further, in the case of the third exemplary embodiment, the pointing coordinate specification device 13 existing on the PC 1 side may well be disposed on the pointing apparatus 3 side so as to perform the processing up to the pointing coordinate specification process on the pointing apparatus 3 side. In this case, as the constituents of the pointing apparatus 3, the pointing coordinate specification device 13 is disposed in addition to the imaging device 32, the pointing coordinate motion vector calculation device 33 and the imaged image information storage device (frame buffer) 34. Herein, the pointing coordinate specification device 13 existing on the pointing apparatus 3 side, performs the pointing coordinate specification process by using the imaged image from the imaging device 32 and the pointing coordinate motion vector calculated by the pointing coordinate motion vector calculation device 33, and further, acquiring the display image displayed at the imaging point of time, from the display image information storage device 11 on the PC 1 side, and sends the pointing coordinates thus specified, to the PC 1 side (the display image information generation device 12).

An advantage of providing the pointing coordinate specification device 13 on the pointing apparatus 3 side so as to perform the processing up to the pointing coordinate specification process on the pointing apparatus 3 side in this manner, is that, when viewed from the PC 1 side, the pointing apparatus 3 can be regarded as a mere device. Specifically, when the display image information is merely transmitted to the device (pointing apparatus 3), the absolute coordinate information is transmitted from the device. Therefore, any complicated process need not be especially performed on the PC 1 side. It is dispensed with to install any complicated hardware or software for image processing and the quantity of arithmetic operations on the PC 1 side can be curtailed.

### Fourth Exemplary Embodiment

The fourth exemplary embodiment will be described on an example in which any command is given to the PC 1 at the pointing coordinate position obtained by being pointed at by the pointing apparatus 3 in the first, second or third exemplary embodiments explained above. A process corresponding to the command is performed in the PC 1, thereby to make the result of the process reflectable at the pointer cursor position. Incidentally, the case of acquiring the pointing position as the absolute coordinates will be described here.

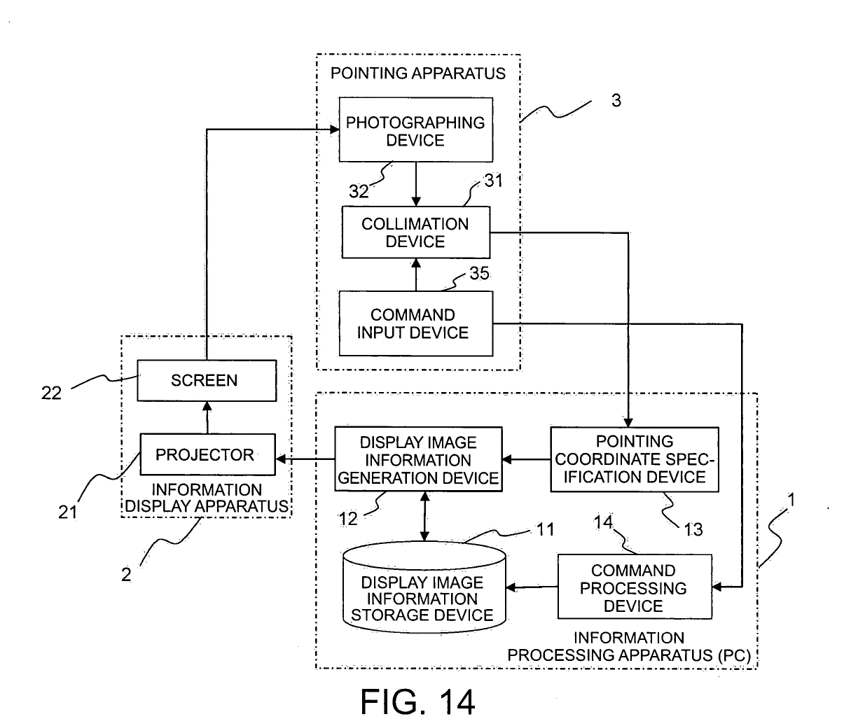

FIG. 14 is a schematic for realizing the fourth exemplary embodiment. It differs from the schematic shown in FIG. 1, merely in the point that a command input device 35 is disposed on the pointing apparatus 3 side, while a command processing device 14 is disposed in the PC 1. The other constituents are the same as in FIG. 1, so that the same reference numerals are assigned to identical portions, which shall be omitted from description. It is assumed also in the fourth exemplary embodiment that the camera built-in type portable telephone 3 be employed as the pointing apparatus 3.

Since, in this case, the pointing apparatus 3 is the camera built-in portable telephone 3, a key input portion disposed in the camera built-in portable telephone 3 can be used as the command input device 35. It is assumed that various commands be generable by manipulating the key input portion.

The command processing device 14 executes a process corresponds to the command given from the camera built-in type portable telephone 3.

The command from the camera built-in type portable telephone 3 may be transmitted to the PC 1 through the Internet or the like by using a communication function included in, for example, this camera built-in type portable telephone 3, or it may well be transmitted to the PC 1 directly by infrared transmission or the like. Such communication devices are variously considered.

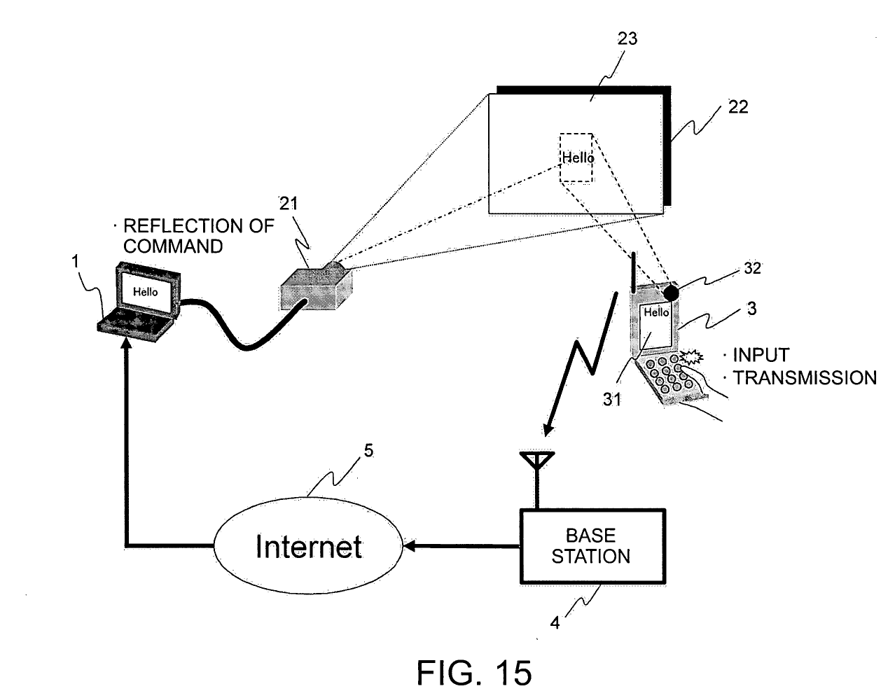

FIG. 15 shows an example in which a command is inputted from the camera built-in type portable telephone 3 to a certain pointing position of the display image 23 projected on the screen 22 (to a pointing coordinate position pointed at by the camera built-in type portable telephone 3), and the result of a process complying with the command is reflected. In the example of FIG. 15, the command from the camera built-in type portable telephone 3 is exemplified as being transmitted from a base station 4 to the PC 1 through the Internet 5 or the like.

In this example, the command outputted from the camera built-in type portable telephone 3 is to display the word of “Hello” at the pointing position P (refer to FIG. 2) pointed at by the camera built-in type portable telephone 3. Specifically, a process to acquire pointing coordinates indicative of the display position of a pointer cursor is performed by the steps explained in the first exemplary embodiment. The command to display the word of “Hello” is generated on the resulting pointing coordinates of the pointer mark, whereupon the PC 1 side accepts the command and displays “Hello” on the pointing coordinates of the pointer cursor at that point of time.

Such a command execution process on the pointing coordinates of the pointer cursor is permitted for the reason that the PC 1 can grasp the coordinates which have been pointed at by the pointing apparatus 3.

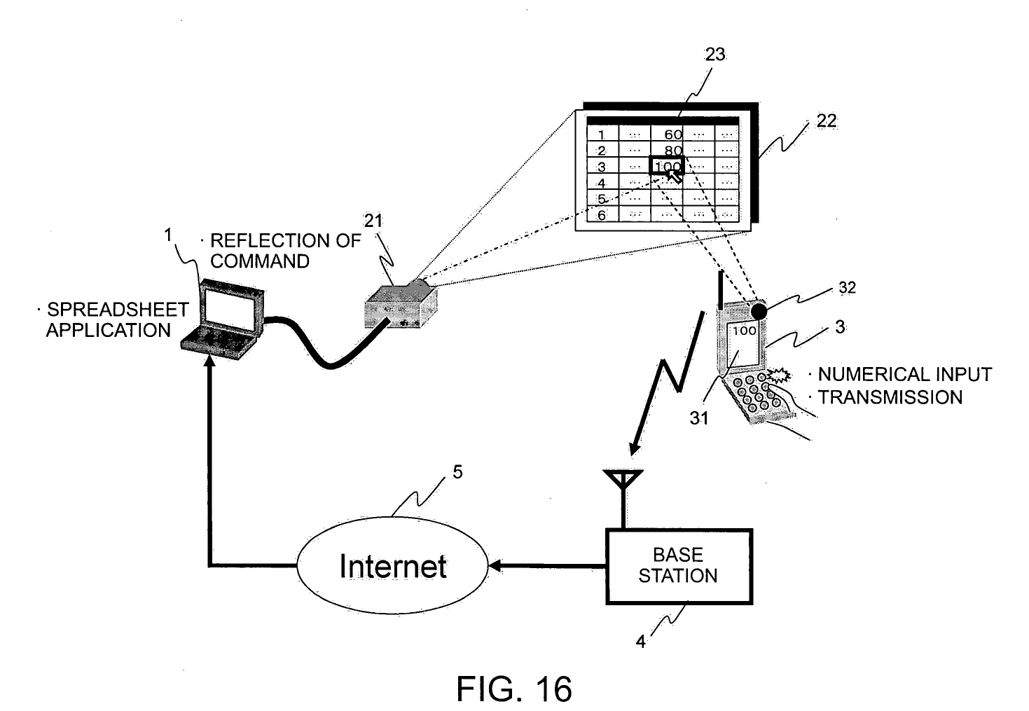

FIG. 16 concerns another command input different from the command input in FIG. 15, and shows an example in which a numerical value is displayed on the pointing coordinates of a pointer mark. In this case, a numerical input for a command is given from the camera built-in type portable telephone 3, whereupon on the PC 1 side, a spreadsheet application, for example, operates to execute a process complying with the command, so as to display the result of the process at the pointed/pointing coordinates.

Each of the above examples has been described using the command input and the process complying with the command, in the case of acquiring the coordinates of the pointing position as absolute coordinates. But a command input and a corresponding process can be executed in substantially the same way even in a case where the coordinates of a pointing position are acquired as relative coordinates.

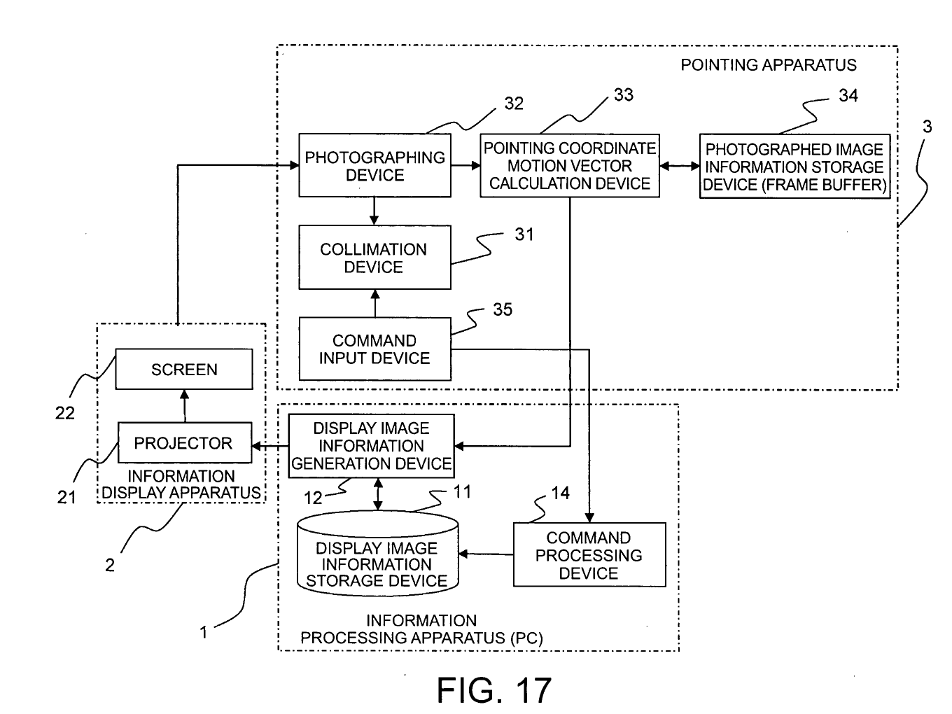

FIG. 17 is a schematic for explaining a command input and a process complying with the command, in the case where the coordinates of a pointing position are acquired as relative coordinates (in the case of the second exemplary embodiment). It differs from the schematic shown in FIG. 5, merely in the point that a command input device 35 is disposed on the pointing apparatus 3 side, while a command processing device 14 is disposed in the PC 1, and the other constituents are the same as in FIG. 5, so that the same reference numerals are assigned to identical portions, which shall be omitted from description.

Also in this case, any command is generated for the pointing coordinates of a pointer cursor obtained by steps as explained in the foregoing second exemplary embodiment, whereupon a process corresponding to the command is executed on the PC 1 side, whereby a processed result for the command can be reflected on the pointing coordinates of the pointer cursor at that point of time.

It is a matter of course that, also in the third exemplary embodiment, a command input can be given in the same manner as in the first or second exemplary embodiment.

The present invention is not restricted to the foregoing exemplary embodiments. It can be variously modified and performed within a scope not departing from the purport of the invention. By way of example, although each of the foregoing exemplary embodiments has been described on the pointing manipulation for the display image projected on the screen by the projector in the presentation hall or the like, the display device in the present invention is not restricted to the projector, but the invention can be applied to various display devices, such as a liquid crystal monitor connected to a personal computer (PC), and it is also applicable to various game machines and equipment.

The present invention can create a processing program in which the processing steps to incarnate the invention described above are described. It can record the processing program in a record medium such as floppy disk, optical disk or hard disk, so that the invention shall include also the record medium, in which the processing program is recorded. Moreover, the processing program may be obtained from a network.

What is claimed is:

1. An information display system, comprising:
an information processing apparatus;
an information display apparatus which displays information held in the information processing apparatus, on a display surface; and
a pointing apparatus which points at an arbitrary position on a display image displayed by the information display apparatus; the pointing apparatus including,
an imaging device that images a range containing the position at which the pointing apparatus is to point on the display image, and outputs imaged image information corresponding to the range; and
the information processing apparatus including,
a pointing coordinate specification device to accept the imaged image information from the pointing apparatus, decide which part of display image information corresponding to the display image at an imaging point of time the imaged image information corresponds to, and specify coordinates of the position at which the pointing apparatus is to point, as pointing coordinates from a result of the decision,
a display image information storage device to store the display image information therein, and
a display image information generation device to composite and display a pointer cursor to and at the specified pointing coordinates on the display image information.

2. An information display system, comprising:
an information processing apparatus;
an information display apparatus which displays information held in the information processing apparatus, on a display surface; and
a pointing apparatus which points at an arbitrary position on a display image displayed by the information display apparatus; the pointing apparatus including an imaging device that images a range containing the position at which the pointing apparatus is to point on the display image, and outputs imaged image information corresponding to the range, and
a pointing coordinate specification device to accept the imaged image information from the imaging device, decide which part of display image information corresponding to the display image at an imaging point of time the imaged image information corresponds to, and specify coordinates of the position at which the pointing apparatus is to point, as pointing coordinates from a result of the decision; and
the information processing apparatus including a display image information storage device to store the display image information therein, and
a display image information generation device to composite and display a pointer cursor to and at the specified pointing coordinates on the display image information.

3. An information display system, comprising:
an information processing apparatus;
an information display apparatus which displays information held in the information processing apparatus, on a display surface; and
a pointing apparatus which points at an arbitrary position on a display image displayed by the information display apparatus; the pointing apparatus including an imaging device that images a range containing the position at which the pointing apparatus is to point on the display image, and outputs imaged image information corresponding to the range; and
the information processing apparatus including a pointing coordinate specification device to accept the imaged image information from the pointing apparatus, decide which part of display image information corresponding to the display image at an imaging point of time the imaged image information corresponds to, and specify coordinates of the position at which the pointing apparatus is to point, as pointing coordinates from a result of the decision,
a display image information storage device to store therein the display image information corresponding to the display image, and
a display image information generation device to generate the image information stored in the display image information storage device, as the display image information, and composite and display a pointer cursor to and at the pointing coordinates on the display image information as specified by the pointing coordinate specification device.

4. An information display system, comprising:
an information processing apparatus;
an information display apparatus which displays information held in the information processing apparatus, on a display surface; and
a pointing apparatus which points at an arbitrary position on a display image displayed by the information display apparatus; the pointing apparatus including an imaging device that images a range containing the position at which the pointing apparatus is to point on the display image, and outputs imaged image information corresponding to the range, and
a pointing coordinate specification device to accept the imaged image information from the imaging device, decide which part of display image information corresponding to the display image at an imaging point of time the imaged image information corresponds to, and specify coordinates of the position at which the pointing apparatus is to point, as pointing coordinates from a result of the decision; and
the information processing apparatus including a display image information storage device to store therein the display image information corresponding to the display image, and
a display image information generation device to generate the image information stored in the display image information storage device, as the display image information, and composite and display a pointer cursor to and at the pointing coordinates on the display image information as specified by the pointing coordinate specification device.

5. The information display system as defined in claim 1, further comprising:
the range to be imaged being a imagable range which is set by a collimation device included in the imaging device, and the central part of the imagable range set by the collimation device being the position at which the pointing apparatus is to point, the coordinates of the position being acquired as the pointing coordinates.

6. The information display system as defined in claim 1, further comprising:
the decision on which part of the display image information corresponding to the display image at the imaging point of time the imaged image information corresponds to, being rendered by generating template image information from the imaged image information, and then performing pattern matching between the template image information and the display image information corresponding to the display image at the imaging point of time.

7. The information display system as defined in claim 1, the pointing apparatus being a portable information equipment which has an imaging function and a communication function.

8. The information display system as defined in claim 1, further comprising:
the pointing apparatus including a command input device, the information processing apparatus including a command processing device to accept and process a command from the pointing apparatus, and that, in the information processing apparatus, when the command is given from the command input device after the specification of the pointing coordinates, the command process being performed so as to reflect a result of the process on the pointing coordinates.

9. An information processing apparatus for use in the information display system as defined in claim 1, comprising:
functions of accepting the imaged image information outputted from the pointing apparatus, deciding which part of the display image information corresponding to the display image at the imaging point of time the imaged image information corresponds to, specifying the position at which the pointing apparatus is to point, as the pointing coordinates from the result of the decision, and thereafter compositing and displaying the pointer cursor to and at the specified pointing coordinates on the display image information.

10. A pointing apparatus for use in the information display system as defined in claim 2, comprising:
functions of deciding which part of the display image information corresponding to the display image at the imaging point of time the imaged image information by the imaging device corresponds to, and specifying the coordinates of the position at which the pointing apparatus is to point, as the pointing coordinates from the result of the decision.

11. A data processing program for the information processing apparatus, in which data processing to be performed by the information processing apparatus as defined in claim 9 comprises:
accepting the imaged image information outputted from the pointing apparatus, and deciding which part of the display image information corresponding to the display image at the imaging point of time the imaged image information corresponds to, and
specifying the position at which the pointing apparatus is to point, as the pointing coordinates from the result of the decision, and thereafter compositing and displaying the pointer cursor to and at the specified pointing coordinates on the display image information.

12. A data processing program for the pointing apparatus, in which data processing steps to be performed by the pointing apparatus as defined in claim 10 comprises:
deciding which part of the display image information corresponding to the display image at the imaging point of time the imaged image information from the imaging device corresponds to, and
specifying the coordinates of the position at which the pointing apparatus is to point, as the pointing coordinates from the result of the decision.

13. A pointer cursor display method in an information display system having an information processing apparatus, an information display apparatus which displays information held in the information processing apparatus, on a display surface, and a pointing apparatus which points at an arbitrary position on a display image displayed by the information display apparatus, comprising:
the pointing apparatus images a range containing the position at which it is to point on the display image, by an imaging device included in the pointing apparatus, and outputs imaged image information corresponding to the range, onto the information processing apparatus; and
the information processing apparatus side accepts the imaged image information from the pointing apparatus, decides which part of display image information corresponding to the display image at an imaging point of time the imaged image information corresponds to, specifies the position at which the pointing apparatus is to point, as pointing coordinates from a result of the decision, and thereafter composites and displays a pointer cursor to and at the specified pointing coordinates on the display image information.

14. A pointer cursor display method in an information display system having an information processing apparatus, an information display apparatus which displays information held in the information processing apparatus, on a display surface, and a pointing apparatus which points at an arbitrary position on a display image displayed by the information display apparatus, comprising:
the pointing apparatus images a range containing the position at which it is to point on the display image, by an imaging device included in the pointing apparatus, obtains imaged image information corresponding to the range, decides which part of display image information corresponding to the display image at an imaging point of time the imaged image information corresponds to, specifies the position at which the pointing apparatus is to point, as pointing coordinates from a result of the decision, and outputs pointing coordinate information for the specified pointing coordinates, to the information processing apparatus side; and
the information processing apparatus side composites and displays a pointer cursor to and at the pointing coordinate corresponding to the pointing coordinate information delivered from the pointing apparatus.

15. The pointer cursor display method in the information display system as defined in claim 13, further comprising:
the range to be imaged being a imagable range which is set by a collimation device included in the imaging device, and the central part of the imagable range set by the collimation device being the position at which the pointing apparatus is to point, coordinates of the position being acquired as the pointing coordinates.

16. The pointer cursor display method in the information display system as defined in claim 13, further comprising:
the decision on which part of the display image information corresponding to the display image at the imaging point of time the imaged image information corresponds to being rendered by generating template image information from the imaged image information, and then performing pattern matching between the template image information and the display image information corresponding to the display image at the imaging point of time.

17. An information display system, comprising:
an information processing apparatus;
an information display apparatus which displays information held in the information processing apparatus, on a display surface; and
a pointing apparatus which points at an arbitrary position on a display image displayed by the information display apparatus; the pointing apparatus including an imaging device that images an arbitrary range which is to be imaged by the pointing apparatus, and outputs imaged image information corresponding to the range, and
a pointing coordinate motion vector calculation device to compare the imaged image information at a current point of time and imaged image information temporally preceding the current point of time, as obtained by imaging a plurality of times, by or without, changing at least one of an imaging position and an imaging angle based on the imaging device, and then calculates a pointing coordinate motion vector from a result of the comparison; and
the information processing apparatus includes a display image information storage device to store therein display image information corresponding to the display image, and
a display image information generation device to composite a pointer cursor displayed on the display image information at the current point of time, to the display image information, and then display the pointer cursor at the position which is distant, in correspondence with the pointing coordinate motion vector calculated by the pointing apparatus.

18. An information display system, comprising:
an information processing apparatus;
an information display apparatus which displays information held in the information processing apparatus, on a display surface; and
a pointing apparatus which points at an arbitrary position on a display image displayed by the information display apparatus; the pointing apparatus including an imaging device that images a certain arbitrary range, and outputs imaged image information corresponding to the range; and
the information processing apparatus includes a pointing coordinate motion vector calculation device to compare the imaged image information at a current point of time as obtained from the imaging device of the pointing apparatus and imaged image information temporally preceding the current point of time, as obtained by imaging a plurality of times, by or without, changing at least one of an imaging position and an imaging angle of the imaging device of the pointing apparatus, and then calculate a pointing coordinate motion vector from a result of the comparison,
a display image information storage device to store therein display image information corresponding to the display image, and
a display image information generation device to composite a pointer cursor displayed on the display image information at the current point of time, to the display image information, and then display the pointer cursor at the position which is distant, in correspondence with the pointing coordinate motion vector calculated by the pointing coordinate motion vector calculation device.

19. An information display system, comprising:
an information processing apparatus;
an information display apparatus which displays information held in the information processing apparatus, on a display surface; and
a pointing apparatus which points at an arbitrary position on a display image displayed by the information display apparatus; the pointing apparatus including an imaging device that images an arbitrary range which is to be imaged by the pointing apparatus, and outputs imaged image information corresponding to the range,
an imaged image information storage device to store therein imaged image information temporally preceding a current point of time, as obtained by imaging a plurality of times, by or without, changing at least one of an imaging position and an imaging angle based on the imaging device, and
a pointing coordinate motion vector calculation device to compare the imaged image information at the current point of time and the imaged image information stored in the imaged image information storage device, and then calculate a pointing coordinate motion vector from a result of the comparison; and
the information processing apparatus includes a display image information storage device to store therein display image information corresponding to the display image, and
a display image information generation device to generate the image information stored in the display image information storage device, as the display image information, and composite a pointer cursor displayed on the display image information at the current point of time, to the display image information, and then display the pointer cursor at the position which is distant in correspondence with the pointing coordinate motion vector calculated by the pointing apparatus.

20. An information display system, comprising:
an information processing apparatus;
an information display apparatus which displays information held in the information processing apparatus, on a display surface; and
a pointing apparatus which points at an arbitrary position on a display image displayed by the information display apparatus; the pointing apparatus including an imaging device that images a certain arbitrary range, and outputs imaged image information corresponding to the range; and
the information processing apparatus includes an imaged image information storage device to store therein imaged image information temporally preceding a current point of time, as obtained by imaging a plurality of times, by or without, changing at least one of an imaging position and an imaging angle of the imaging device of the pointing apparatus,
a pointing coordinate motion vector calculation device to compare the imaged image information at the current point of time as obtained from the imaging device of the pointing apparatus and the imaged image information stored in the imaged image information storage device, and then calculate a pointing coordinate motion vector from a result of the comparison,
a display image information storage device to store therein display image information corresponding to the display image, and
a display image information generation device to generate the image information stored in the display image information storage device, as the display image information, and composite a pointer cursor displayed on the display image information at the current point of time, to the display image information, and then displaying the pointer cursor at the position which is distant in correspondence with the pointing coordinate motion vector calculated by the pointing coordinate motion vector calculation device.

21. The information display system as defined in claim 17, further comprising:
in that the process to compare the imaged image information at the current point of time and the imaged image information temporally preceding the current point of time and then calculating the pointing coordinate motion vector from the result of the comparison performs pattern matching between template image information generated from the imaged image information at the current point of time and the imaged image information temporally preceding the current point of time, thereby to decide which part of the imaged image information temporally preceding the current point of time the imaged image information at the current point of time corresponds to, whereupon it finds a movement magnitude and a moving direction of the imaged image information at the current point of time, on the basis of a result of the decision, so as to calculate the pointing coordinate motion vector from the found movement magnitude and moving direction.

22. The information display system as defined in claim 17, the pointing apparatus being a portable information equipment which has an imaging function and a communication function.

23. The information display system as defined in claim 17, further comprising:
the pointing apparatus including a command input device, the information processing apparatus including a command processing device to accept and process a command from the pointing apparatus, and that, in the information processing apparatus, when the command is given from the command input device after specification of pointing coordinates, the command process is performed so as to reflect a result of the process on the pointing coordinates.

24. The pointing apparatus for use in the information display system as defined in claim 17, further comprising:
functions of comparing the imaged image information at the current point of time and the imaged image information temporally preceding the current point of time, as are obtained in such a way that the arbitrary range is imaged the plurality of times, by or without, changing at least one of the imaging position and the imaging angle of the imaging device included in the pointing apparatus, by the imaging device, and then calculating the pointing coordinate motion vector from the result of the comparison, so as to output the pointing coordinate motion vector to the information processing apparatus.

25. An information processing apparatus for use in the an information display system as defined in claim 18, further comprising:
functions of comparing the imaged image information at the current point of time and the imaged image information temporally preceding the current point of time, as are obtained in such a way that the imaging is performed the plurality of times, by or without, changing at least one of the imaging position and the imaging angle of the imaging device included in the pointing apparatus, calculating the pointing coordinate motion vector from the result of the comparison, and compositing the pointer cursor displayed on the display image at the current point of time, to the display image information, and then displaying the pointer cursor at the position which is distant in correspondence with the calculated pointing coordinate motion vector.

26. A data processing program for a pointing apparatus, in which data processing to be performed by the pointing apparatus as defined in claim 24 comprises:
comparing the imaged image information at the current point of time and the imaged image information temporally preceding the current point of time, as are obtained in such a way that the arbitrary range is imaged the plurality of times, by or without, changing at least one of the imaging position and the imaging angle, by the imaging device included in the pointing apparatus, and then calculating the pointing coordinate motion vector from the result of the comparison; and
the outputting the pointing coordinate motion vector to the information processing apparatus.

27. A data processing program for an information processing apparatus, in which data processing to be performed by the information processing apparatus as defined in claim 25 comprises:
comparing the imaged image information at the current point of time and the imaged image information temporally preceding the current point of time, as are obtained in such a way that the imaging is performed the plurality of times, by or without, changing at least one of the imaging position and the imaging angle of the imaging device included in the pointing apparatus, and then calculating the pointing coordinate motion vector from the result of the comparison; and
the compositing the pointer cursor displayed on the display image at the current point of time, to the display image information, and then displaying the pointer cursor at the position which is distant in correspondence with the calculated pointing coordinate motion vector.

28. A pointer cursor display method in an information display system having an information processing apparatus, an information display apparatus which displays information held in the information processing apparatus, on a display surface, and a pointing apparatus which points at an arbitrary position on a display image displayed by the information display apparatus, comprising:
the pointing apparatus compares imaged image information at a current point of time and imaged image information temporally preceding the current point of time, as are obtained in such a way that an arbitrary range is imaged a plurality of times, by or without, changing at least one of an imaging position and an imaging angle of an imaging device included in the pointing apparatus, by the imaging device, whereupon a pointing coordinate motion vector is calculated from a result of the comparison, so as to output the pointing coordinate motion vector to the information processing apparatus; and
the information processing apparatus composites a pointer cursor displayed on the display image at the current point of time, to the display image information, and displays the pointer cursor at the position which is distant in correspondence with the pointing coordinate motion vector calculated by the pointing apparatus.

29. A pointer cursor display method in an information display system having an information processing apparatus, an information display apparatus which displays information held in the information processing apparatus, on a display surface, and a pointing apparatus which points at an arbitrary position on a display image displayed by the information display apparatus, comprising:
the pointing apparatus images an arbitrary range by an imaging device included in the pointing apparatus; and
that the information processing apparatus side compares imaged image information at a current point of time and imaged image information temporally preceding the current point of time, as are obtained by imaging a plurality of times, by or without, changing at least one of an imaging position and an imaging angle of the imaging device included in the pointing apparatus, calculates a pointing coordinate motion vector from a result of the comparison, and composites a pointer cursor displayed on the display image at the current point of time, to the display image information, and displays the pointer cursor at the position which is distant in correspondence with the calculated pointing coordinate motion vector.

30. The pointer cursor display method in the information display system as defined in claim 28, further comprising:
the process to compare the imaged image information at the current point of time and the imaged image information temporally preceding the current point of time and then calculate the pointing coordinate motion vector from the result of the comparison, performs pattern matching between template image information generated from the imaged image information at the current point of time and the imaged image information temporally preceding the current point of time, thereby to decide which part of the imaged image information temporally preceding the current point of time the imaged image information at the current point of time corresponds to, whereupon it finds a movement magnitude and a moving direction of the imaged image information at the current point of time, on the basis of a result of the decision, so as to calculate the pointing coordinate motion vector from the found movement magnitude and moving direction.

31. An information display system, comprising:
an information processing apparatus;
an information display apparatus which displays information held in the information processing apparatus, on a display surface; and
a pointing apparatus which points at an arbitrary position on a display image displayed by the information display apparatus; the pointing apparatus including an imaging device that images an arbitrary range which is to be imaged by the pointing apparatus, and outputting imaged image information corresponding to the range, and
a pointing coordinate motion vector calculation device to compare the imaged image information at a current point of time and imaged image information temporally preceding the current point of time, as obtained by imaging a plurality of times, by or without, changing at least one of an imaging position and an imaging angle based on the imaging device, and then calculating a pointing coordinate motion vector from a result of the comparison; and
the information processing apparatus includes a display image information storage device to store therein display image information corresponding to the display image,
a pointing coordinate specification device to find a tentative pointing position of a pointer cursor after being moved, on the basis of the display image information, the imaged image information from the pointing apparatus, and the pointing coordinate motion vector, and specifying a pointing position of the pointer cursor after being moved, as pointing coordinates within a range containing the tentative pointing position, and
a display image information generation device to composite and display the pointer cursor to and at the specified pointing coordinates on the display image information.

32. An information display system, comprising:
an information processing apparatus;
an information display apparatus which displays information held in the information processing apparatus, on a display surface; and
a pointing apparatus which points at an arbitrary position on a display image displayed by the information display apparatus; the pointing apparatus including an imaging device capable of imaging an arbitrary range which is to be imaged by the pointing apparatus, and outputting imaged image information corresponding to the range; and
the information processing apparatus includes a pointing coordinate motion vector calculation device to compare the imaged image information at a current point of time and imaged image information temporally preceding the current point of time, as obtained by imaging a plurality of times, by or without, changing at least one of an imaging position and an imaging angle attained by the imaging device of the pointing apparatus, and then calculating a pointing coordinate motion vector from a result of the comparison,
a display image information storage device to store therein display image information corresponding to the display image,
a pointing coordinate specification device to find a tentative pointing position of a pointer cursor after being moved, on the basis of the display image information, the calculated pointing coordinate motion vector, and the imaged image information from the pointing apparatus, and specify a pointing position of the pointer cursor after being moved, as pointing coordinates within a range containing the tentative pointing position, and
a display image information generation device to composite and display the pointer cursor to and at the specified pointing coordinates on the display image information.

33. An information display system, comprising:
an information processing apparatus;
an information display apparatus which displays information held in the information processing apparatus, on a display surface; and
a pointing apparatus which points at an arbitrary position on a display image displayed by the information display apparatus; the pointing apparatus including an imaging device that images an arbitrary range which is to be imaged by the pointing apparatus, and outputs imaged image information corresponding to the range,
a pointing coordinate motion vector calculation device to compare the imaged image information at a current point of time and imaged image information temporally preceding the current point of time, as obtained by imaging a plurality of times, by or without, changing at least one of an imaging position and an imaging angle based on the imaging device, and then calculating a pointing coordinate motion vector from a result of the comparison, and
a pointing coordinate specification device to find a tentative pointing position of a pointer cursor after being moved, on the basis of the imaged image information, the pointing coordinate motion vector, and the display image information, and then specifying a pointing position of the pointer cursor after being moved, as pointing coordinates within a range containing the tentative pointing position; and
the information processing apparatus includes a display image information storage device to store therein display image information corresponding to the display image, and
a display image information generation device to composite and display the pointer cursor to and at the specified pointing coordinates on the display image information.

34. The information display system as defined in claim 31, further comprising:
the pointing coordinate specification process, which is performed by the pointing coordinate specification device, sets the range with reference to the tentative pointing position, computes correlations at respective positions by performing pattern matching between the imaged image and the display image information at the imaging point of time within the set range, and specifies the pointing coordinates after the motion, on the basis of the computed correlations.

35. An information processing apparatus for use in the information display system as defined in claim 31, further comprising:
functions of finding the tentative pointing position of the pointer cursor after being moved, on the basis of the display image information stored in the display image information storage device, the imaged image information from the pointing apparatus, and the pointing coordinate motion vector, specifying the pointing position of the pointer cursor after being moved, as the pointing coordinates within the range containing the tentative pointing position, and compositing and displaying the pointer cursor to and at the specified pointing coordinates.

36. The pointing apparatus for use in an information display system as defined in claim 31, further comprising:
functions of comparing the imaged image information at the current point of time and the imaged image information temporally preceding the current point of time, as are obtained in such a way that the arbitrary range is imaged the plurality of times by or without, changing at least one of the imaging position and the imaging angle, of the imaging device included in the pointing apparatus, by the imaging device, and then calculating the pointing coordinate motion vector from the result of the comparison, so as to output the pointing coordinate motion vector to the information processing apparatus.

37. An information processing apparatus for use in the information display system as defined in claim 32, further comprising:
functions of comparing the imaged image information at the current point of time and the imaged image information temporally preceding the current point of time, as are obtained in such a way that the arbitrary range is imaged the plurality of times, by or without, changing at least one of the imaging position and the imaging angle of the imaging device included in the pointing apparatus, by the imaging device, calculating the pointing coordinate motion vector from the result of the comparison, finding the tentative pointing position of the pointer cursor after being moved, on the basis of the calculated coordinate motion vector, the imaged image information, and the display image information, specifying the pointing position of the pointer cursor after being moved, as the pointing coordinates within the range containing the tentative pointing position, and compositing and displaying the pointer cursor to and at the specified pointing coordinates.

38. A pointing apparatus for use in the information display system as defined in claim 33, further comprising:
functions of comparing the imaged image information at the current point of time and the imaged image information temporally preceding the current point of time, as are obtained in such a way that the arbitrary range is imaged the plurality of times, by or without, changing at least one of the imaging position and the imaging angle of the imaging device included in the pointing apparatus, by the imaging device calculating the pointing coordinate motion vector from the result of the comparison, finding the tentative pointing position of the pointer cursor after being moved, on the basis of the pointing coordinate motion vector, the imaged image information at the imaging point of time, and the display image information, and specifying the pointing position of the pointer cursor after being moved, as the pointing coordinates within the range containing the tentative pointing position.

39. A data processing program of an information processing apparatus, in which data processing to be performed by the information processing apparatus as defined in claim 35, comprises:
finding the tentative pointing position of the pointer cursor after being moved, on the basis of the display image information stored in the display image information storage device, the imaged image information from the pointing apparatus, and the pointing coordinate motion vector;
the specifying the pointing position of the pointer cursor after being moved, as the pointing coordinates within the range containing the tentative pointing position; and
compositing and displaying the pointer cursor to and at the specified pointing coordinates.

40. A data processing program of a pointing apparatus, in which data processing to be performed by the pointing apparatus as defined in claim 36 comprises:
comparing the imaged image information at the current point of time and the imaged image information temporally preceding the current point of time, as are obtained in such a way that the arbitrary range is imaged the plurality of times, by or without, changing at least one of the imaging position and the imaging angle of the imaging device included in the pointing apparatus, by the imaging device and then calculating the pointing coordinate motion vector from the result of the comparison; and
outputting the pointing coordinate motion vector to the information processing apparatus.

41. A data processing program of an information processing apparatus, in which data processing to be performed by the information processing apparatus as defined in claim 37:
comparing the imaged image information at the current point of time and the imaged image information temporally preceding the current point of time, as are obtained in such a way that the arbitrary range is imaged the plurality of times, by or without, changing at least one of the imaging position and the imaging angle of the imaging device included in the pointing apparatus, by the imaging device, and then calculating the pointing coordinate motion vector from the result of the comparison;
finding the tentative pointing position of the pointer cursor after being moved, on the basis of the calculated coordinate motion vector, the imaged image information, and the display image information,
specifying the pointing position of the pointer cursor after being moved, as the pointing coordinates within the range containing the tentative pointing position; and
compositing and displaying the pointer cursor to and at the specified pointing coordinates.

42. A data processing program of a pointing apparatus, in which data processing steps to be performed by the pointing apparatus as defined in claim 38, comprises:
comparing the imaged image information at the current point of time and the imaged image information temporally preceding the current point of time, as are obtained in such a way that the arbitrary range is imaged the plurality of times, by or without, changing at least one of the imaging position and the imaging angle of the imaging device included in the pointing apparatus, by the imaging device, and then calculating the pointing coordinate motion vector from the result of the comparison;
finding the tentative pointing position of the pointer cursor after being moved, on the basis of the pointing coordinate motion vector, the imaged image information at the imaging point of time, and the display image information; and
specifying the pointing position of the pointer cursor after being moved, as the pointing coordinates within the range containing the tentative pointing position.

43. A pointer cursor display method in an information display system having an information processing apparatus, an information display apparatus which displays information held in the information processing apparatus, on a display surface, and a pointing apparatus which points at an arbitrary position on a display image displayed by the information display apparatus, comprising:
the pointing apparatus compares imaged image information at a current point of time and imaged image information temporally preceding the current point of time, as are obtained in such a way that an arbitrary range is imaged a plurality of times, by or without, changing at least one of an imaging position and an imaging angle of an imaging device included in the pointing apparatus, by the imaging device, a pointing coordinate motion vector is calculated from a result of the comparison, so as to output the pointing coordinate motion vector to the information processing apparatus; and
the information processing apparatus finds a tentative pointing position of a pointer cursor after being moved, on the basis of the imaged image information from the pointing apparatus, the pointing coordinate motion vector, and the display image information, specifies a pointing position of the pointer cursor after being moved, as pointing coordinates within a range containing the tentative pointing position, and composites and displays the pointer cursor to and at the specified pointing coordinates on the display image information corresponding to the display image.

44. A pointer cursor display method in an information display system having an information processing apparatus, an information display apparatus which displays information held in the information processing apparatus, on a display surface, and a pointing apparatus which points at an arbitrary position on a display image displayed by the information display apparatus, comprising:
the pointing apparatus images an arbitrary range by an imaging device included in the pointing apparatus; and
the information processing apparatus compares imaged image information at a current point of time and imaged image information temporally preceding the current point of time, as are obtained by imaging a plurality of times, by or without, changing at least one of an imaging position and an imaging angle of the imaging device included in the pointing apparatus, by the imaging device, calculates a pointing coordinate motion vector from a result of the comparison, finds a tentative pointing position of a pointer cursor after being moved, on the basis of the calculated coordinate motion vector, the imaged image information, and the display image information corresponding to the display image, specifies a pointing position of the pointer cursor after being moved, as pointing coordinates within a range containing the tentative pointing position, and composites and displays the pointer cursor to and at the specified pointing coordinates on the display image information.

45. A pointer cursor display method in an information display system having an information processing apparatus, an information display apparatus which displays information held in the information processing apparatus, on a display surface, and a pointing apparatus which points at an arbitrary position on a display image displayed by the information display apparatus, comprising:
the pointing apparatus compares imaged image information at a current point of time and imaged image information temporally preceding the current point of time, as are obtained by imaging an arbitrary range a plurality of times, by or without, changing at least one of an imaging position and an imaging angle of an imaging device included in the pointing apparatus, by the imaging device, calculates a pointing coordinate motion vector from a result of the comparison, that it finds a tentative pointing position of a pointer cursor after being moved, on the basis of the pointing coordinate motion vector, and the display image information corresponding to the display image, and specifies a pointing position of the pointer cursor after being moved, as pointing coordinates within a range containing the tentative pointing position; and
the information processing apparatus composites and displays the pointer cursor to and at the specified pointing coordinates on the display image information.

46. The pointer cursor display method in the information display system as defined in claim 43, further comprising:
the pointing coordinate specification process sets the range with reference to the tentative pointing position, computes correlations at respective positions by performing pattern matching between the imaged image and the display image information at the imaging point of time within the set range, and specifies the pointing coordinates after the motion, on the basis of the computed correlations.
